(19) United States
(12) Patent Application Publication
(10) Pub. No.: US 2015/0254186 A1
(43) Pub. Date: Sep. 10, 2015

(54) INFORMATION PROCESSING DEVICE HAVING A PLURALITY OF TYPES OF MEMORY CACHES WITH DIFFERENT CHARACTERISTICS

(71) Applicant: HITACHI, LTD., Tokyo (JP)

(72) Inventors: Sadahiro Sugimoto, Tokyo (JP); Akira Yamamoto, Tokyo (JP); Shigeo Homma, Tokyo (JP)

(21) Appl. No.: 14/430,643

(22) PCT Filed: Oct. 23, 2013
(86) PCT No.: PCT/JP2013/078731

§ 371 Date: Mar. 24, 2015

(30) Foreign Application Priority Data
Dec. 28, 2012 (JP) PCT/JP2012/008459

(51) Int. Cl. G06F 12/08; G06F 3/06

(52) U.S. Cl. CPC G06F 12/0866; G06F 3/0611; G06F 3/0656; G06F 3/0659; G06F 3/068; G06F 2212/1024; G06F 2212/152; G06F 2212/205; G06F 2212/21; G06F 2212/222; G06F 2212/283; G06F 2212/313

(57) ABSTRACT

An information processing apparatus comprises a plurality types of cache memories having different characteristics, decides on a type of cache memory to be used as a data cache destination based on the access characteristics of cache-target data, and caches the data in the cache memory of the decided type.

### TECHNICAL FIELD

The present invention relates to technology for controlling a data cache.

### BACKGROUND ART

A kind of semiconductor nonvolatile memory, a flash memory is known. The flash memory (FM) makes it possible to increase storage density and lower the cost per capacity (bit costs) easier than with DRAM, SRAM or other such volatile memories (written as RAM hereinafter). Furthermore, the flash memory enables data to be accessed faster than in a magnetic disk or the like. Thus, the use of flash memory as a disk cache makes it possible to create a low-cost, high capacity disk cache.

However, flash memory has the following restrictions. First of all, updating of flash memory bits is limited to one direction from 1 to 0 (or 0 to 1). Then, in a case where a bit has to be changed to the opposite value, data must be erased from the “FM block”, and all the bits in the block must be configured to 1 (or 0). A plurality of the blocks (physical blocks) that the flash memory has is called the FM block. Each FM block is comprised of multiple pages (physical pages). There is also an upper limit on the number of times a FM block can be erased in a flash memory, and, for example, in the case of a SLC (Single Level Cell) NAND-type flash memory, the upper limit on the number of erases is somewhere between 10,000 and 100,000 times, and in the case of a MLC (Multiple Level Cell) NAND-type flash memory, the upper limit on the number of erases is around several thousand times. Thus, in a case where a flash memory is used as a disk cache, there is the fear that a high frequency of rewriting will cause the number of erases to reach the upper limit in a relatively short period of time, making the flash memory unusable.

In addition, the access performance of a flash memory is lower than that of a RAM, thereby raising the fear that using a flash memory instead of a RAM in a disk cache will result in the disk cache becoming a bottleneck to system performance.

In addition to flash memory, nonvolatile semiconductor memories, such as phase-change memory, magnetoresistive random access memory, and resistive random access memory have also been developed, and these nonvolatile semiconductor memories also offer greater storage densities than the RAM and can achieve higher capacities at lower costs than the RAM. However, these nonvolatile semiconductor memories also tend to be slower and to have shorter life spans than the RAM.

Methods that use a volatile memory (RAM) as a primary disk cache and a nonvolatile memory auxiliary are known. For example, Patent Literature 1 discloses such a method.

### CITATION LIST

### Patent Literature

[PTL 1]

U.S. Pat. No. 8,131,930

### SUMMARY OF INVENTION

### Technical Problem

A flash memory or other such nonvolatile semiconductor memory generally has characteristics that offer lower access performance than a RAM and higher access performance than a HDD. Thus, as in Patent Literature 1, a system, which uses a flash memory as a cache between a RAM cache and a final storage destination (a final storage device) of the data, such as a HDD, is utilized.

However, as is explained above, there is a constraint of number of erases for the semiconductor nonvolatile memories such as the flash memory, and in a case where high-frequency rewriting is performed, the number of erases reaches the upper limit in a comparatively short period of time, and cannot be used (that is, has short lifetime). Generally, the access frequency of the disk cache is higher than the access frequency of a final storage device such as a HDD. Therefore, in a case of using the flash memory as the disk cache, there is a high possibility that the flash memory cannot be used anymore in a shorter period (cannot withstand use for a long period) compared to a case where the flash memory is used as the final storage device. Even in a device configuration in which a flash memory portion can be replaced, if the flash memory portion has short life time, then a replacement frequency of the portion becomes high, thereby raising a maintenance cost of the device.

Further, as in PTL1, in a cache system having a hierarchical structure of a RAM and a flash memory like this, for example, in a case where read-target data is stored in the flash memory, the read-target data is temporarily staged in the RAM cache, and thereafter, the relevant data is sent to the host computer, and as such, the overhead of staging process is generated. In view of the growth in performance requirements for storage systems in recent times, this performance overhead cannot be ignored, and I/O processing systems with lower performance overhead are required.

As mentioned above, since the access performance of nonvolatile semiconductor memories, such as a flash memory, is generally lower than that of a RAM, there is the fear of a disk cache, which uses a nonvolatile semiconductor memory, becoming a system performance bottleneck.

### Solution to Problem

An information processing apparatus of the present invention comprises a plurality types of cache memories having different characteristics, and based on the access characteristics of cache-target data, decides on the type of cache memory to be used as the cache destination of the data, and caches the data in the cache memory of the decided type. The information processing apparatus, for example, may be a storage apparatus, which comprises multiple storage devices, and a controller coupled to the multiple storage devices. The controller may comprise the plurality types of cache memories mentioned above, and a control device coupled to these plurality types of cache memories. Each of the multiples storage devices, for example, may be a final storage device, which will be explained further below.

In one embodiment of the present invention, as the plurality types the cache memories having different characteristics, a flash memory and a RAM are used. When comparing characteristics of the flash memory and the RAM, there are differences of the characteristics, such that the flash memory has lower access performance compared to the RAM, and that the flash memory has limitations on the number of rewrites, and the like. Therefore, the information processing apparatus caches data matching the characteristics of the RAM to the cache memory using the RAM, and caches data matching the characteristics of the flash memory to the cache memory using the flash memory. Specifically, the information processing apparatus performs control such that data required to have high throughput, or determined to have high update frequency, is not written to the cache memory using the flash memory, but is directly cached to the cache memory using the RAM.

### Advantageous Effects of Invention

According to the present invention, it becomes possible to utilize the storage medium such as the flash memory which is lower-priced than the RAM and has higher access performance than HDD, in addition to the higher-priced RAM, so that it becomes possible to provide the information processing device configured to have the lower-priced large-capacity cache.

### BRIEF DESCRIPTION OF DRAWINGS

FIG. 1 is a conceptual drawing showing an overview of a caching destination selection process related to Example 1.

FIG. 2 is a drawing showing a first example of the configuration of an information system related to Example 1.

FIG. 3 is a drawing showing a second example of the configuration of the information system related to Example 1.

FIG. 4 is a block diagram of an FM board related to Example 1.

FIG. 5 is a block diagram of a RAM in a storage controller related to Example 1.

FIG. 6 is a block diagram of an access monitor table related to Example 1.

FIG. 7 is a conceptual drawing of a cache management data structure related to Example 1.

FIG. 8 is a drawing showing a data structure, which is part of the cache management data structure related to Example 1.

FIG. 9 is a drawing showing the data structures of a dirty queue and a clean queue related to Example 1.

FIG. 10 is a drawing showing the data structures of a FM free queue and a RAM free queue related to Example 1.

FIG. 11 is a flowchart of a read command process related to Example 1.

FIG. 12 is a flowchart of a staging process related to Example 1.

FIG. 13 is a flowchart of a data send process related to Example 1.

FIG. 14 is a flowchart of a cache allocation process related to Example 1.

FIG. 15 is a flowchart of a FM priority segment allocation process related to Example 1.

FIG. 16 is a flowchart of a RAM priority segment allocation process related to Example 1.

FIG. 17 is a flowchart of an access monitor tabulation process related to Example 1.

FIG. 18 is a drawing illustrating a determination threshold calculation method related to Example 1.

FIG. 19 is a flowchart of a write command process related to Example 1.

FIG. 20 is a flowchart of a data receive process (RAM) related to Example 1.

FIG. 21 is a flowchart of a data receive process (FM) related to Example 1.

FIG. 22 is a flowchart of a FM data read process related to Example 1.

FIG. 23 is a flowchart of a FM data write process related to Example 1.

FIG. 24 is a block diagram of an information system related to Example 2.

FIG. 25 is a drawing showing an overview of data input/output processing related to Example 2.

FIG. 26 is a drawing showing the configuration of an information system related to Example 3.

FIG. 27 is a drawing showing an overview of a data input/output process related to Example 3.

FIG. 28 is a block diagram of a job control table related to Example 4.

FIG. 29 is a first flowchart of a read command process related to Example 4.

FIG. 30 is a second flowchart of the read command process related to Example 4.

FIG. 31 is a flowchart of a staging process related to Example 4.

FIG. 32 is a flowchart of a data send process related to Example 4.

FIG. 33 is a flowchart of a memory type revision process related to Example 5.

FIG. 34 is a conceptual drawing showing a relationship between a logical volume and a cache management data according to examples of the present invention.

### DESCRIPTION OF EMBODIMENT

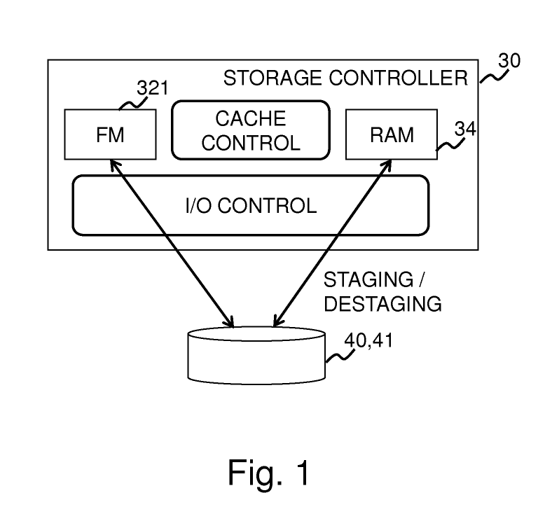

First, explanation will be given on an outline of the present invention. FIG. 1 is a conceptual drawing showing an overview of a caching destination selection process, in a storage system which is an example of the information processing apparatus of the present invention.

As electronic information handled by companies and organizations is increasing rapidly, performances of IT systems demanded by users are increasing year after year, in order to process large amount of data more rapidly. On the other hand, need for reducing cost of the IT systems is also high, and high-performance but low-priced information processing apparatus is demanded from users. For example, in a computer system in which large amount of data access is generated, quality of the performance of the storage system for storing data greatly varies the performance of the system.

In order to improve an access performance thereof, the storage system is provided with a cache (a disk cache). Generally, as a cache, a random access memory (hereinafter referred to as “RAM”), such as DRAM and SRAM, that is a storage medium with higher access performance than hard disks and the like as the final storage destination (a final storage device) of the data, is widely used. A drawback of the RAM is that it is highly priced (high bit cost), so that it is possible to improve an average performance of the storage system if the cache using RAM is mounted in large number, but there is a problem that the system becomes high priced.

As is shown in FIG. 1, the storage system according to the present invention is equipped with a FM 321 and a RAM 34 on a storage controller 30 as a cache, and caches data stored in HDD 40 or SSD 41 as the final storage device to either of the FM 321 or the RAM 34. Since the FM has lower bit cost compared to the RAM, the storage device according to the present invention is capable of providing a cache storage area with lower price and large capacity.

On the other hand, when comparing characteristics of the FM and the RAM, there are differences of the characteristics, such that the FM has lower access performance compared to the RAM, and that the FM has limitations on the number of rewrites, and the like. Therefore, in accordance with the access characteristics of cache-target data, the storage controller 30 performs the control of selecting the RAM 34 as a cache destination for data matching the characteristics of the RAM, and selecting the FM 321 as the cache destination for data matching the characteristics of the flash memory. As the access characteristics of the data, for example, an access frequency or an access pattern of the cache-target data is used, and for example, the storage controller 30 do not write data required to have high throughput, or with high update frequency, to the cache memory using the flash memory, and selects the RAM 34 as the cache destination.

By doing so, it becomes possible to realize a storage system capable of appropriately using the storage medium with lower price than the RAM and higher access performance than the HDD, such as the flash memory, as the cache, in addition to the high-priced RAM. The storage system of the present invention is especially suitable for the use in the computer system which executes a business application performing data access with respect to large-volume data, such as an on-line transaction process (OLTP) and ERP (Enterprise Resource Planning) and the like.

A number of examples will hereinafter be explained by referring to the drawings. In the following explanation, information is explained using an expression such as “aaa table”, but this information may also be expressed using a data structure other than a table. Thus, to show that this information is not dependent on the data structure, “aaa table” may be called “aaa information”.

In the following explanation, there may be cases where an explanation is given using a “program” as the doer of the action, but since the stipulated processing is performed in accordance with a program being executed by a control device comprising a processor (typically, a CPU (Central Processing Unit)) while using a memory and an I/F (interface), the explanation may have either the processor or the control device as the doer of the action. The control device may be a processor, or may comprise a processor and a hardware circuit. A process, which is disclosed as having the program as the doer of the action, may be regarded as a process performed by a host computer or a storage system. Furthermore, either all or a portion of a program may be realized using dedicated hardware. Various types of programs may be installed in respective computers using a program distribute server or computer readable storage media. The storage media, for example, may include an IC card, a SD card, a DVD, and the like.

### Example 1

An information system related to Example 1 will be explained first.

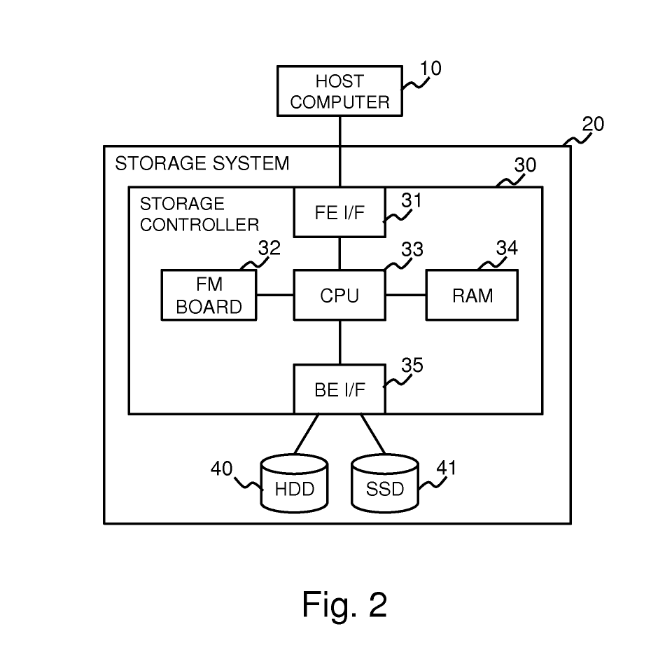

FIG. 2 is a drawing showing a first example of the configuration of an information system related to Example 1.

The information system comprises a host computer 10 and a storage system 20 (an example of an information processing apparatus), which is coupled to the host computer either directly or via a network. The storage system 20 comprises a storage controller 30, and a HDD (Hard Disk Drive) 40 and/or SSD (Solid State Drive) 41 coupled to the storage controller 30. The HDD 40 and/or the SSD 41 are examples of storage devices. The HDD 40 and/or the SSD 41 may be built into the storage controller 30.

The storage controller 30 comprises one or more front-end interfaces (FE I/F) 31, one or more backend interfaces (BE I/F) 35, one or more FM (flash memory) boards 32, a CPU 33, and a RAM (Random Access Memory) 34. The RAM 34 is a memory (memory device), and is an example of a cache memory.

The storage controller 30 according to Example 1 of the present invention creates one or a plurality of logical volumes (substantive logical volumes) from a plurality of storage devices (the HDD 40 or the SSD 41), and provides the same to the host computer 10 (to make the host computer 10 recognize the created logical volume). Alternatively, the storage controller 30 provides the logical volume (a virtual logical volume, and storage area is allocated dynamically to each region within the virtual logical volume) created by a so-called thin provisioning technique to the host computer 10. The host computer 10 issues an I/O command (a write command or a read command) designating the provided logical volume (the substantive logical volume or the virtual logical volume) and a position within the logical volume (a logical block number, which is sometimes abbreviated as LBA), and performs a read/write process of data with respect to the logical volume. However, the present invention is effective even to an embodiment in which the storage controller 30 does not provide the logical volume, for example, a configuration in which the storage system 20 provides each HDD 40 and each SSD 41 respectively as an individual storage device to the host computer 10. Here, the logical volume that the host computer recognizes may sometimes be referred to as a logical unit (sometimes abbreviated as LU), and in the present specification, the terms logical volume and the logical unit (LU) are used to mean the same concept, unless specified otherwise.

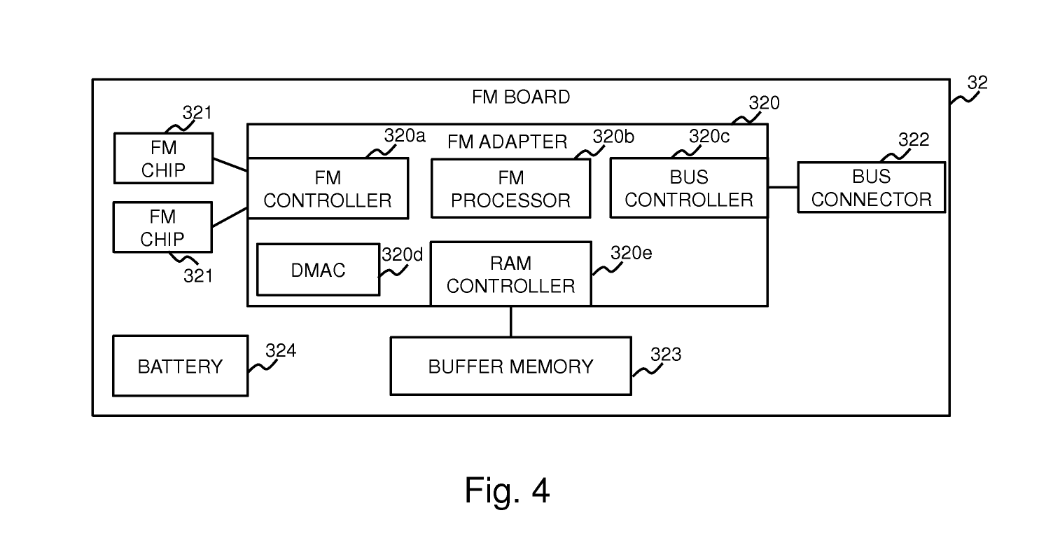

The FE I/F 31 is an interface device for communicating with the host computer 10. The BE I/F 35 is an interface device for communicating with either the HDD 40 or the SSD 41. The BE I/F 35, for example, is a SAS or a Fibre Channel interface device. The FM board 32 is a board mounted with an FM chip 321 (refer to FIG. 4). The CPU 33 executes various types of processing. The RAM 34 stores a program, which is executed by the CPU 33, and various types of tables. The RAM 34 comprises a cache memory area, and the cache memory area is comprised of multiple cache segments. A cache segment is a unit area managed by the CPU 33. For example, in a cache memory area in the RAM 34, an area reservation, a data read, and a data write may be performed in units of cache segments. Data read from a final storage device and data written to the final storage device (typically, user data, which is data conforming to an I/O command (either a write command or a read command) from the host computer 10) are cached (temporarily stored) in the cache memory area. The final storage device is the storage device in which is stored data for which an I/O is performed by the storage controller 30 in accordance with an I/O destination specified in an I/O command. Specifically, for example, data conforming to an I/O command (a write command) is temporarily stored in the cache memory area, and thereafter is stored in a region of the storage device constituting a logical unit (a virtual logical volume) (in a case where the logical volume is a virtual logical volume, the data is stored in a region of the storage device allocated to the logical volume). The final storage device means a storage device which forms the logical volume. In this example, the final storage device is either a HDD or a SSD, but may be another type of storage device, for example, an external storage system comprising multiple storage devices.

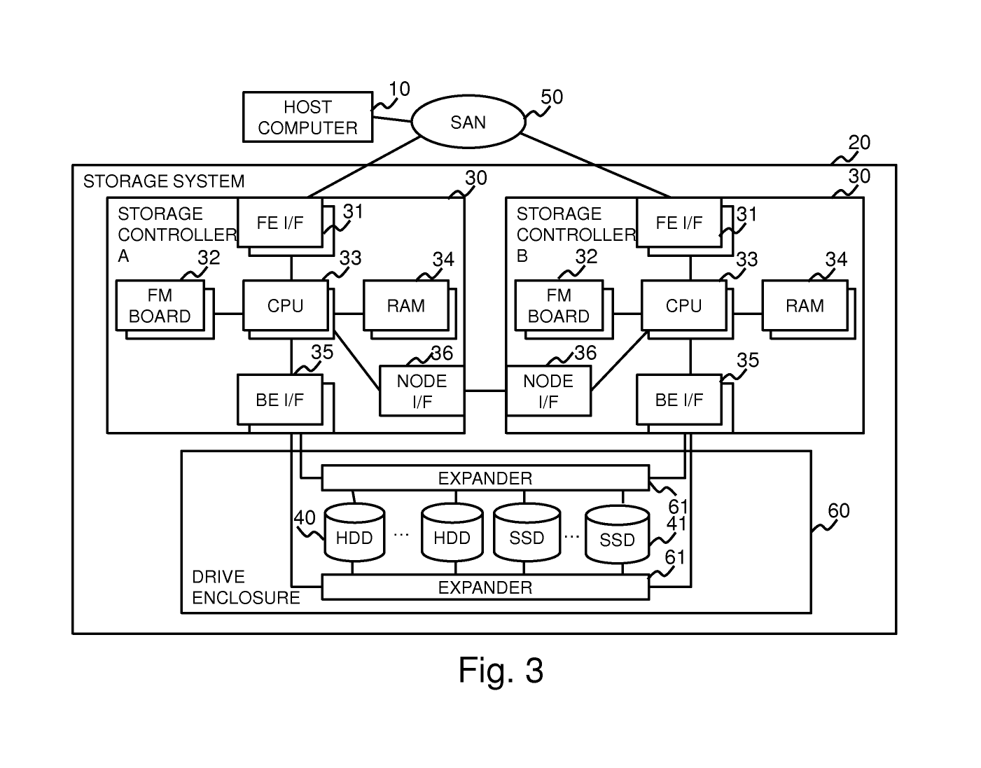

In FIG. 2, one each of the respective components of the information system is shown in the drawing, but the information system may comprise multiple of each component in order to realize redundancy, higher performance, and greater capacity. Furthermore, the respective components may be coupled together via a network. The network may include a switch, an expander, and so forth. For example, a configuration like that of FIG. 3 is conceivable as the information system.

FIG. 3 is a drawing showing a second example of the configuration of the information system related to Example 1.

The information system shown in FIG. 3 comprises two storage controllers 30 (storage controller A and storage controller B), and these storage controllers 30 are coupled via a node interface (a node I/F) 36. The node interface 36, for example, may be a network interface device, such as Infiniband, Fibre Channel (FC), Ethernet (registered trademark), or the like, or may be a path interface device, such as PCI-Express.

These storage controllers 30 are coupled to the host computer 10 via a Fibre Channel, Ethernet, Infiniband or other such network 50. In FIG. 3, the network 50 is referred to using the generic term SAN (Storage Area Network).

The information system comprises a drive enclosure 60. The drive enclosure 60 houses multiple HDDs 40 and SSDs 41. The multiple HDDs 40 and SSDs 41 are coupled to an expander 42 inside the drive enclosure 60. The expander 42 is coupled to the BE I/F 35 of each storage controller 30. In a case where the BE I/F 35 is a SAS interface device, the expander 42, for example, is a SAS Expander, and in a case where the BE I/F 35 is a Fibre Channel interface device, the expander 42, for example, is a FC switch.

In FIG. 3, the storage system 20 comprises one drive enclosure 60, but the storage system 20 may comprise multiple drive enclosures 60. In accordance with this, each drive enclosure 60 may be directly coupled to each of multiple ports of the BE I/F 35, or multiple drive enclosures 60 may be coupled to a BE I/F 35 port via a switch. Furthermore, multiple drive enclosures 60 may be coupled to the BE I/F 35 port by linking these multiple drive enclosures 60 together in accordance with cascading the expanders 42 of each drive enclosure 60.

FIG. 4 is a block diagram of a FM board related to Example 1.

The FM board 32 comprises one or more flash memory (FM) chips 321, a FM adapter 320, a bus connector 322, a buffer memory 323, and a battery 324. In this example and the examples that follow, a FM board 32, which is a memory board comprising a flash memory chip 321, will be explained as a representative example, but a memory board comprising a nonvolatile semiconductor memory other than a flash memory, for example, a PRAM (phase-change memory), a MRAM (magnetoresistive random access memory) or a ReRAM (resistive random access memory) may be used instead of the FM board 32. A memory board like the FM board 32 is a memory device, and is an example of a cache memory.

The FM chip 321, for example, is a NAND-type flash memory chip. In this example, multiple FM chips 321 are used as a cache memory area, and are managed as multiple cache segments by the CPU 33. The size of one cache segment, for example, is the size of multiple blocks, which is an erase unit of FM chip 321. The FM chip 321 comprises characteristics, which afford lower access performance than the RAM 34 and restrict the number of times data can be erased. One FM chip 321 comprises multiple FM blocks (physical FM blocks). One physical FM block comprises multiple pages (physical pages).

The bus connector 322 is a connector for coupling the FM board 32 to a PCI Express or other such bus on the storage controller 30. For example, in a case where the FM board 32 and the main substrate of the storage controller 30 are implemented as an integrated unit, the bus connector 322 may be omitted from the configuration.

The buffer memory 323, for example, is a RAM, such as a DRAM or SRAM, and is used as a buffer when transferring data to the FM chip 321 from the outside as well as when transferring data to the outside from the FM chip 321. The buffer memory 323 may store a program executed by a FM processor 320b, and data used by the FM processor 320b, a DMAC 320d, or the like.

The battery 324 is for backing up the power required to store data using the buffer memory 323. Therefore, the buffer memory 323 can continue to store data using the power of the battery 324 even in a case where the power supply from the outside has been shut off.

The FM adapter 320 comprises a FM controller 320a, a FM processor 320b, a bus controller 320c, a DMA (Direct Memory Access) controller (DMAC) 320d, and a RAM controller 320e. The FM adapter 320, for example, is an ASIC or other such integrated circuit. In this example, the FM adapter 320 has a group of circuits for each configuration built into a single integrated circuit, but the FM adapter 320 may also be implemented by dividing these circuits into multiple integrated circuits. The function of a certain circuit (for example, the DMAC 320d) may be replaced with a different circuit (for example, the FM processor 320b).

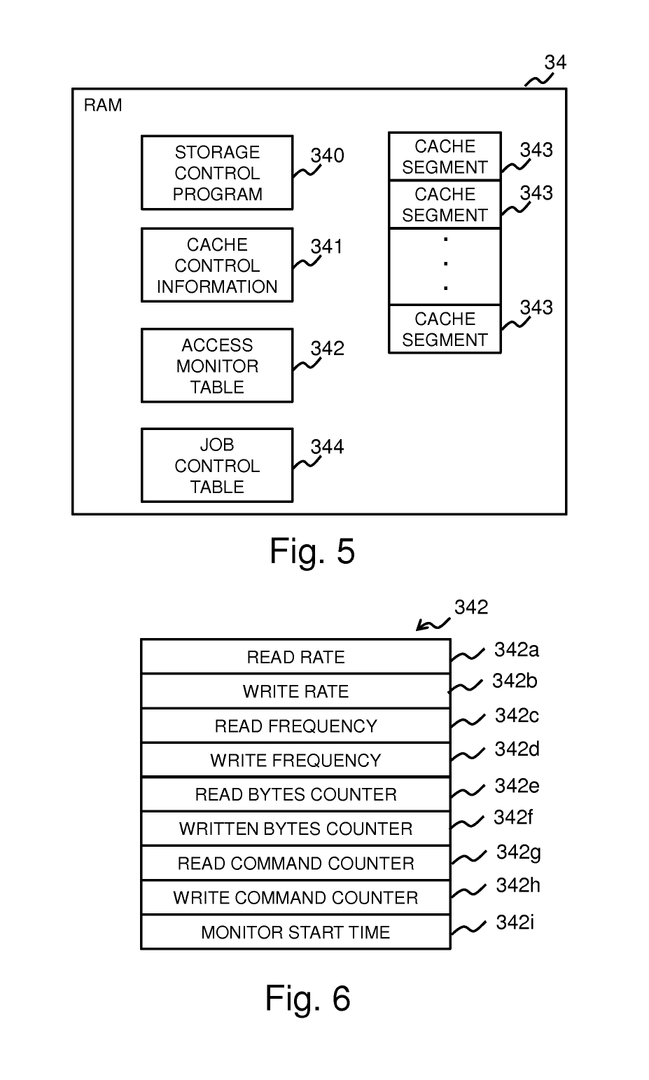

FIG. 5 is a block diagram of a storage controller RAM related to Example 1.

The RAM 34, for example, is a random access memory, such as a DRAM or a SRAM. The RAM 34 stores a storage control program 340 executed by the CPU 33, cache control information 341, an access monitor table 342, and a job control table 344. Also, multiple cache segments 343 for caching and managing data are stored in the RAM 34. Either data to be stored in either the HDD 40 or the SSD 41, or data read from either the HDD 40 or the SSD 41 can be cached in the cache segment 343.

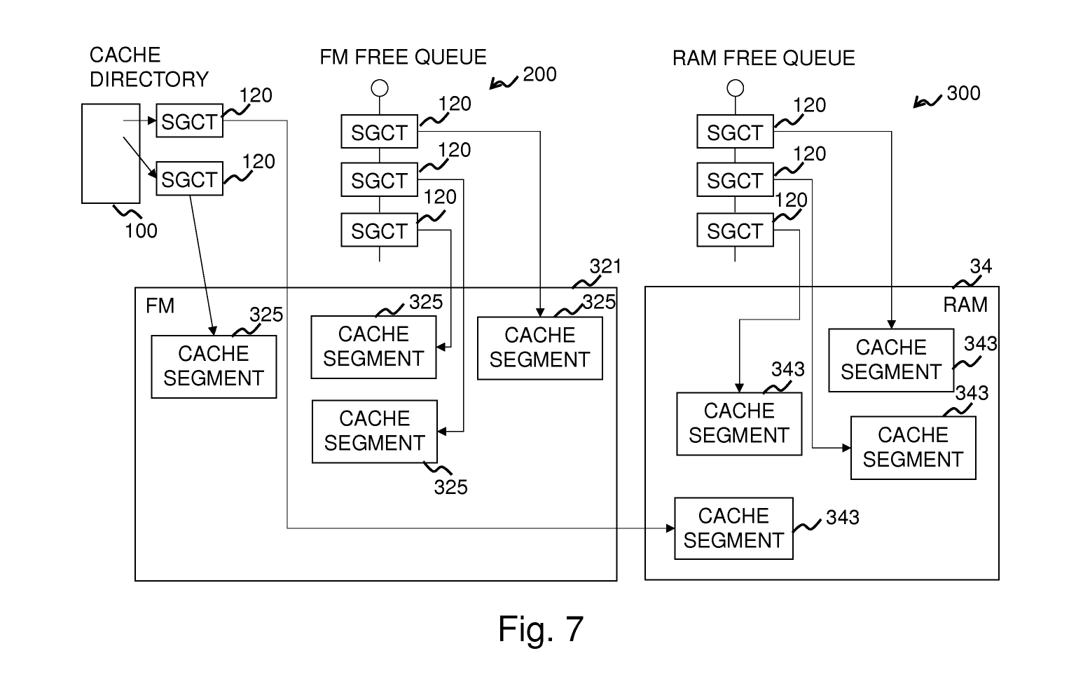

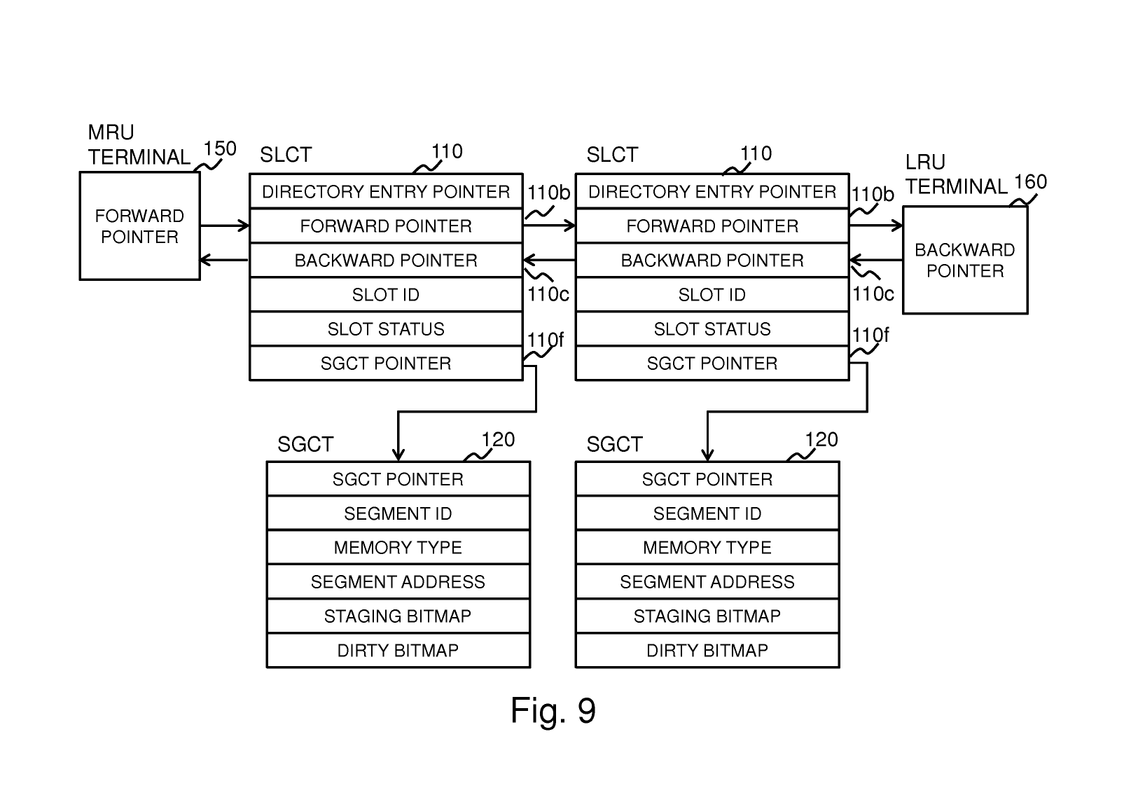

The storage control program 340 is an example of a cache control program, and executes various types of control processes related to the cache. The processing will be explained in detail further below. The cache control information 341 comprises a cache directory 100 (refer to FIG. 7), a clean queue (refer to FIG. 9), a dirty queue (refer to FIG. 9), a FM free queue 200 (refer to FIG. 7), and a RAM free queue 300 (refer to FIG. 7). The data structure related to the cache control information 341 will be explained further below.

As a method for implementing the RAM 34, for example, a memory module such as a DIMM, which mounts multiple RAM memory chips on a substrate, may be configured, and this memory module may be coupled to a memory slot on the main substrate of the storage controller 30. The use of a configuration in which the RAM is mounted on a different substrate than the main substrate of the storage controller 30 makes it possible to maintain and replace the RAM and expand the RAM capacity independently of the main substrate of the storage controller 30. Further, in order to avoid the loss of the memory content on the RAM 34 in a case where unforeseen failure such as a power outage occurs, a configuration in which a battery is provided to maintain the memory content on the RAM 34 during power outage, may be adopted.

FIG. 6 is a block diagram of an access monitor table related to Example 1.

The access monitor table 342 is for storing information for tabulating data read and write rates, and an access frequency for each partial region (area) in a logical unit (a logical volume) of the storage system 20, and, in addition, for storing a tabulation result. The access monitor table 342, for example, stores a read rate 342a, and write rate 342b, a read frequency 342c, a write frequency 342d, a read bytes counter 342e, a written bytes counter 342f, a read command counter 342g, a write command counter 342h, and a monitor start time 342i with respect to each partial region inside the logical unit. As a size of the partial region (that is, a unit in which the access frequency or the access rate is tabulated in one access monitor table 342), various size (provided that it is a size smaller than the size of the logical volume) may be selected. However, as will be explained later, in the storage system of the present invention, the allocation of the cache segment is performed on the basis of the information of the access monitor table 342. Therefore, it is preferable to set the size of the partial region to be the same size as the cache segment, or to an integral multiple of the cache segment.

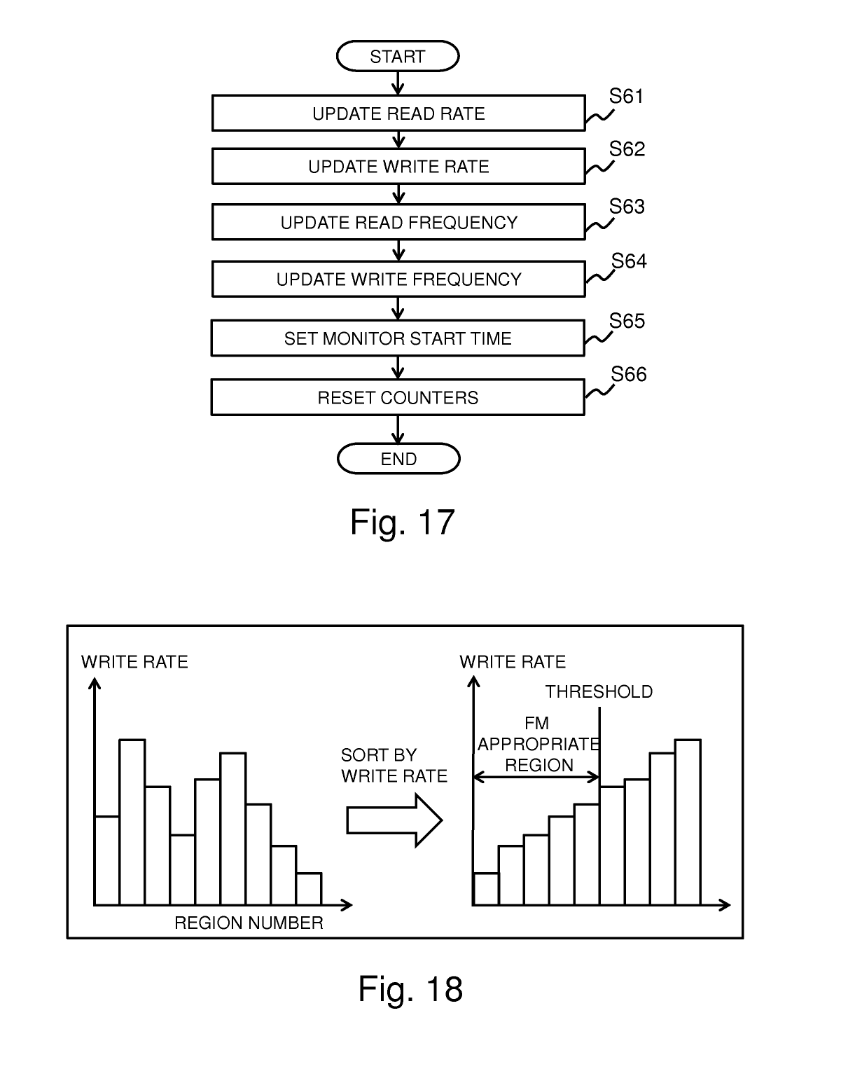

The read rate 342a is the read rate (for example, in units of MB/Sec) with respect to a partial region inside the logical unit. The write rate 342b is the write rate (for example, in units of MB/Sec) with respect to a partial region inside the logical unit. The read frequency 342c is the frequency at which reads occur with respect to a partial region inside the logical unit. The write frequency 342d is the frequency at which writes occur with respect to a partial region inside the logical unit. The read byte counter 342e is a data counter for the bytes of data, which have been read from a partial region inside the logical unit. The written byte counter 342f is a data counter for the bytes of data, which have been written to a partial region inside the logical unit. The read command counter 342g is a counter for the number of commands, which performed a read from a partial region inside the logical unit. The write command counter 342h is a counter for the number of commands, which performed a write to a partial region inside the logical unit. The monitor start time 342i is the time at which monitoring with respect to a partial region inside the logical unit was started. The read byte counter 342e, the written byte counter 342f, the read command counter 342g, and the write command counter 342h are counters used for tabulation, and the read rate 342a, the write rate 342b, the read frequency 342c, and the write frequency 342d are tabulation results. An access monitor tabulation process (refer to FIG. 17) for tabulating the access frequency (read frequency and write frequency) and the data read and write rates (read rate and write rate) with respect to a partial region inside the logical unit of the storage system 20 will be explained further below.

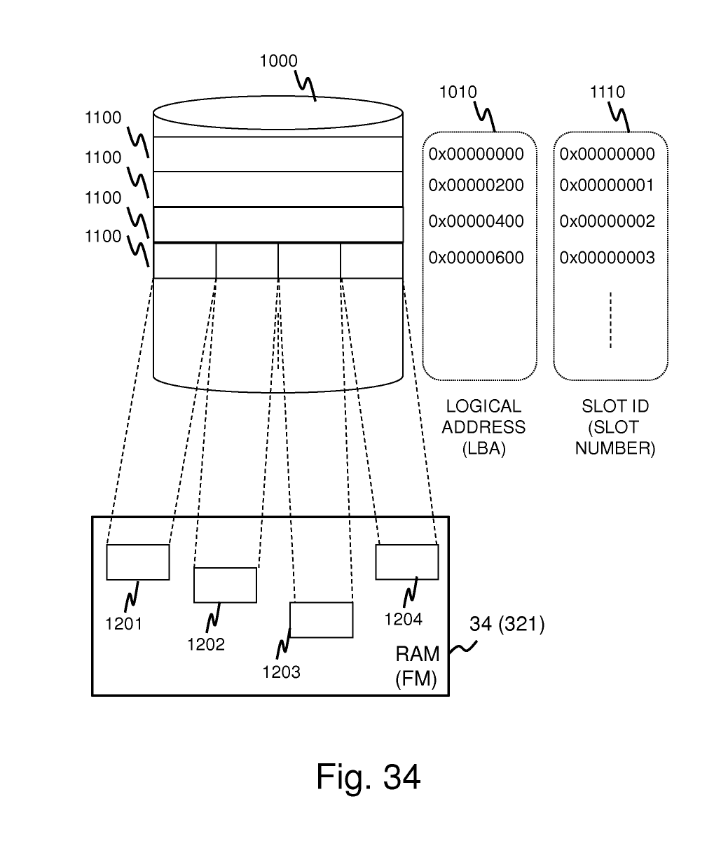

Subsequently, in FIG. 7 onwards, explanation will be given on a cache management data structure related to Example 1. Before going into the details, explanation will be given on an outline of a relationship between the volume (the logical volume) and the cache management data. FIG. 34 is a conceptual drawing showing a relationship between the logical volume, the slot, and the cache segment. When the host computer 10 accesses a logical volume 1000, the minimum access unit is a block (for example, 512 bytes), and each block is applied with the logical block address (LBA, or in the present invention, may sometimes be referred to as a logical address) (an element 1010 in FIG. 34 represents the logical block address). Further, in the storage system 20, an exclusive control is performed, such as during the access to the storage area on the logical volume. In doing so, a concept of a slot 1100 is defined as the unit of the exclusive control. A size of the slot 1100 is, in the example of the present invention, 256 KB (that is, 512 blocks), however, other sizes may be adopted. Each slot 1100 is applied with a unique identification number, which is called a slot ID. In FIG. 34, the element 1100 is the slot ID, and the relationship between the logical block address 1010 and the slot ID 1100 is as shown in FIG. 34. For example, when transforming the logical block address designated in the I/O command which is received from the host computer 10 into the slot ID, a value obtained by dividing the designated logical block address by 512 becomes the slot ID. Further, in a case where a remainder of the division is 0, it is found that the logical block address designated in the I/O command is at a head position of the slot (which is specified by the slot ID), and in a case where the remainder of the division is a value other than 0 (this value will tentatively be called R), the remainder R becomes an information representing that the logical block address designated in the I/O command is at a block existing at a R-th position from the head block of the slot (which is specified by the slot ID) (hereinafter, the information R will be referred to as an in-slot relative address).

Further, in a case where the data on the logical volume is cached, the storage area on the RAM 34 or the FM chip 321 is secured as the cache area. In doing so, the cache area is secured in an area unit of a cache segment (or a segment) (elements 1201, 1202, 1203, and 1204 in FIG. 34 are cache segments. Hereinafter, in a case where the cache segments 1201, 1202, 1203, and 1204 are collectively referred to, a term “cache segment 1200” is used). In the examples of the present invention, the size of the cache segment 1200 is 64 KB, and four cache segments 1201, 1202, 1203, and 1204 are mapped to each slot. FIG. 34 shows a concept in which the area (the cache segment 1200) on the RAM 34 or the FM chip 321 is mapped to the slot 1100. The details of the method in which the storage system 20 manages the mapping will be explained later. The storage system 20 has a slot control table 110 (details thereof will be explained during explanation of FIG. 7. One slot control table 110 exists for one slot 1100) as information for managing the slot, and information of the cache segment 1200 mapped to the slot (to be precise, a pointer to the information for managing the cache segment 1200) is stored in the slot control table 110. By creating and managing the slot control table 110, the storage system 20 manages the mapping of the slot 1100 and the cache segment 1200. Here, it is possible to set the size of the cache segment 1200 to sizes other than 64 KB, and it is possible to set the number of the cache segments 1200 mapped to one slot 1100 to be values other than 4.

An outline of the process related to the management of the cache area, when the host computer 10 accesses (reads or writes and the like) to the area on the logical volume 1000 is as follows. The host computer 10 issues the I/O command specifying a logical unit number (a number specifying the logical unit/logical volume, and is generally abbreviated as LUN (Logical Unit Number)) and the logical block address 1010. The storage system 20 transforms the logical block address contained in the received I/O command to a set of the slot ID 1110 and the in-slot relative address, and refers the slot control table 110 specified by the slot ID 1110 obtained by the transformation. Thereafter, on the basis of the information of the slot control table 110, the storage system 20 determines whether or not the cache segment 1200 is secured with respect to the area on the logical volume that is designated by the I/O command (the area specified by the logical block address). If no cache segment 1200 is secured, then the storage system 20 performs a process of newly securing the cache segment 1200.

Subsequently, explanation will be given on a cache management data structure. FIG. 7 is a conceptual drawing of the cache management data structure related to Example 1.

The cache management data structure comprises a cache directory 100, a FM free queue 200, a RAM free queue 300, a dirty queue, and a clean queue (refer to FIG. 9). In this example, cache segments (343, 325) are managed in the RAM 34 and the FM chip 321. Each cache segment is managed using a segment control table 120 (SGCT: Segment Control Table). The SGCT 120 manages all of the cache segments, which are managed in the RAM 34 and all the FM chips 321, on a one-to-one basis.

The cache directory 100 is a data structure for managing the mapping between a logical address of cache-target data (a logical block address of the logical volume, which is the storage destination of the data stored in the cache segment) and a physical address on the memory (RAM 34 and FM chip 321). The cache directory 100, for example, is a hash table, which uses the cache-target data logical address (or information derived from the logical address, such as the slot ID) as a key, and has as an entry a pointer for showing the SGCT 120. The SGCT 120 manages a pointer to the cache segment (325, 343) corresponding to this SGCT 120. Therefore, according to the cache directory 100, it is possible, based on the cache-target data logical address, to identify a cache segment, which is caching data corresponding to the relevant logical address. The configuration of the SGCT 120 will be explained in detail further below. In this example, the cache directory 100 collectively manages the cache segment 343 of the RAM 34 and the cache segments 325 of all the FM chips 321. Thus, in accordance with referencing the relevant cache directory 100, it is possible to easily determine the cache hits in the RAM 34 and the FM chips 321.

The FM free queue 200 is control information for managing a free segment of an FM chip 321, that is, a cache segment 325 in which no data is stored. The FM free queue 200, for example, is configured as a two-way linked list having a SGCT 120 corresponding to a free segment of the FM chip 321 as an entry. The data structure of the control information for managing the free segment does not have to be a queue, and a stack or the like may be used.

The RAM free queue 300 is control information for managing a free segment of the RAM 34. The RAM free queue 300, for example, is configured as a two-way linked list having a SGCT 120 corresponding to a free segment of the RAM 34 as an entry. The data structure of the control information for managing the free segment does not have to be a queue, and a stack or the like may be used.

The SGCT 120 assumes a state of being coupled to any of the cache directory 100, the FM free queue 200, or the RAM free queue 300 in accordance with the state and type of cache segment corresponding to this SGCT 120. Specifically, the SGCT 120 corresponding to the cache segment 325 of the FM chip 321 is coupled to the FM free queue 200 when the relevant cache segment 325 is not being used, and is coupled to the cache directory 100 when the relevant cache segment 325 is allocated for storing data. Alternatively, the SGCT 120 corresponding to the cache segment 343 of the RAM 34 is coupled to the RAM free queue 300 when the relevant cache segment 343 is not being used, and is coupled to the cache directory 100 when the relevant cache segment 343 is allocated for storing data.

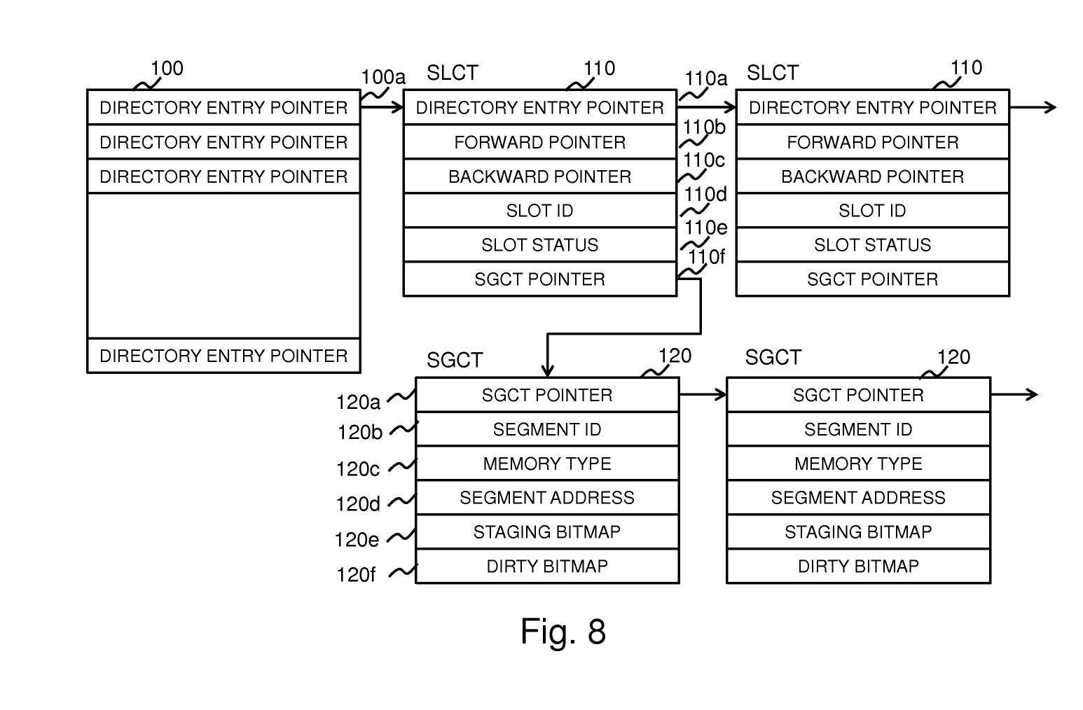

FIG. 8 is a drawing showing a data structure, which is part of the cache management data structure related to Example 1.

The cache directory 100, for example, is a hash table, which treats a slot ID as a key. An entry 100a (a directory entry) of the cache directory 100 stores a directory entry pointer showing a slot control table 110 (SLCT: Slot Control Table) corresponding to the slot ID. The slot here is a data unit (a lock unit) for performing exclusive control. For example, one slot can comprise multiple cache segments. In a case where data is only stored in a portion of the slot, the slot may comprise only one cache segment.

The SLCT 110 comprises a directory entry pointer 110a, a forward pointer 110b, a backward pointer 110c, a slot ID 110d, a slot status 110e, and a SGCT pointer 110f. The directory entry pointer 110a is a pointer which points to a SLCT 110 corresponding to the next entry of the hash table. The forward pointer 110b is a pointer which shows the anterior SLCT 110 in a sequence in either the clean queue or the dirty queue. The backward pointer 110c is a pointer which shows the posterior SLCT 110 in a sequence in either the clean queue or the dirty queue. The slot ID 110d is identification information of the slot corresponding to the SLCT 110. The slot status 110e is information showing the state of the slot. As a slot state, for example, there is “locked”, which shows that the relevant slot is locked. The SGCT pointer 110f is a pointer which points to the SGCT 120 corresponding to the cache segment included in the relevant slot. In a case where no cache segment is allocated to the slot, then the value expressing that the pointer (address) is invalid (for example, NULL) is in the SGCT pointer 110f. In a case where multiple cache segments comprise the slot, each SGCT 120 is managed as a linked list, and the SGCT pointer 110f points to the SGCT 120 corresponding to the first cache segment in the linked list.

The SGCT 120 comprises a SGCT pointer 120a, a segment ID 120b, a memory type 120c, a segment address 120d, a staging bitmap 120e, and a dirty bitmap 120f.

The SGCT pointer 120a is a pointer, which points to the SGCT 120 corresponding to the next cache segment comprising the same slot. The segment ID 120b is cache segment identification information, and is the information representing where in the order in the slot the cache segment is positioned. In the present example, a maximum of four cache segments are allocated to one slot, so that either value of 0, 1, 2, and 3 is stored in the segment ID 120b of each cache segment (the segment ID 120b of the cache segment positioned at the head of the slot becomes 0, and the segment ID 120b of 1, 2, and 3 are allocated sequentially. For example, taking the cache segments 1201 through 1204 in FIG. 34 as an example, the segment ID 120b of the cache segment 1201 corresponded to the head of the slot 1100 is 0, and the segment ID 120b of the cache segments 1202, 1203 and 1204 becomes 1, 2 and 3, respectively). The memory type 120c is the type of cache memory in which the cache segment corresponding to this SGCT 120 is being stored. The cache memory type is either FM or RAM. The segment address 120d is the address of the cache segment. The staging bitmap 120e is a bitmap showing the area in the cache segment in which the clean data, that is, data matching the data in the drive (40, 41), is being cached. In the staging bitmap 120e, each bit corresponds to each area in the cache segment, and a bit corresponding to an area in which valid data (data, which is the same as that in the drive) is being cached is configured to ON (1), and a bit corresponding to an area in which valid data is not being cached is configured to OFF (0). The dirty bitmap 120f is a bitmap showing an area in the cache segment in which dirty data, that is, data, which does not match the data in the drive (or data, which is not reflected in the drive), is being cached. In the dirty bitmap 120f, each bit corresponds to each area in the cache segment, and a bit corresponding to an area in which dirty data is being cached is configured to ON (1), and a bit corresponding to an area in which dirty data is not being cached is configured to OFF (0).

FIG. 9 is a drawing showing the data structures of a dirty queue and a clean queue related to Example 1.

The dirty queue and the clean queue are parts of the cache data management structure. The dirty queue couples the SLCT 110 corresponding to the slot comprising dirty data. The clean queue couples the SLCT 110 corresponding to the slot comprising only clean data. The dirty queue and the clean queue are used in a cache replacement and destage scheduling, and may take a variety of structures depending on the respective cache replacement and destage scheduling schemes. In this example, the algorithm used in a cache replacement and destage scheduling will be explained as LRU (Least Recently Used). The dirty queue and the clean queue will be explained here by giving the dirty queue as an example since the basic configuration of the queues is the same and only the coupled SLCTs 110 differ. The dirty queue is configured as a two-way linked list. That is, the dirty queue couples the SLCT 110 corresponding to a slot comprising recently used dirty data to the forward pointer of a MRU (Most Recently Used) terminal 150, thereafter sequentially couples the SLCT 110 of the next slot in the sequence (the slot comprising the next recently used dirty data) to the forward pointer 110b of the SLCT 110, and couples a LRU terminal 160 to the forward pointer 110b of the last SLCT 110 in the sequence, while coupling the last SLCT 110 in the sequence to the backward pointer of the LRU terminal 160, thereafter sequentially coupling the SLCT 110 of the slot previous thereto in the sequence to the backward pointer 110c of the posterior SLCT 110 in the sequence, and coupling the first SLCT 110 in the sequence to the MRU terminal 150. In the dirty queue, the SLCTs 110 are arranged from the MRU terminal 150 side in reverse chronological order from the time of last use.

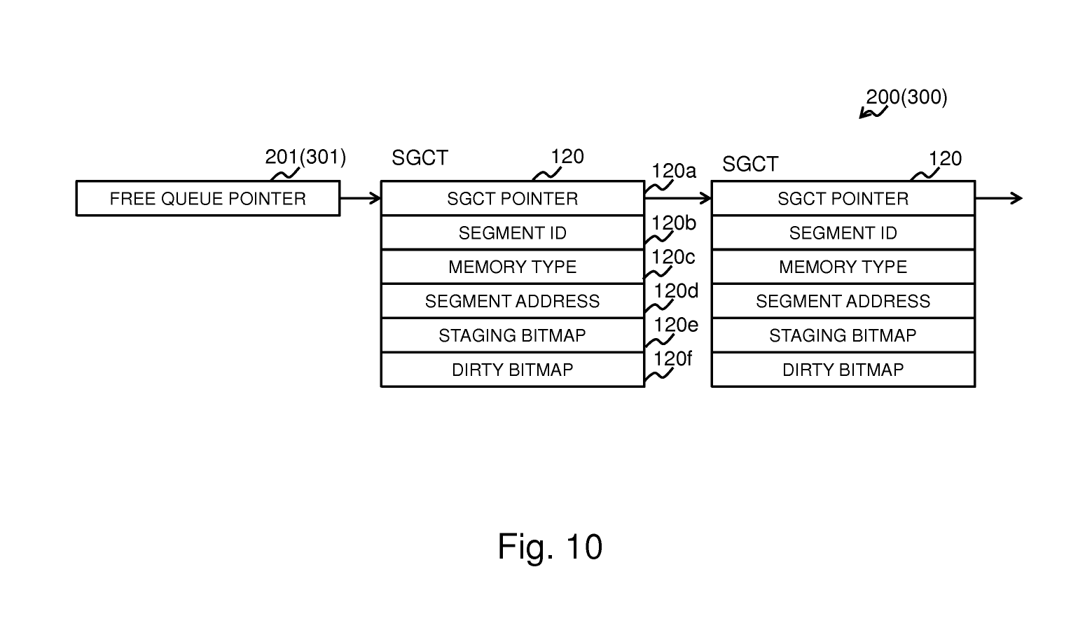

FIG. 10 is a drawing showing the data structures of a FM free queue and a RAM free queue related to Example 1.

The FM free queue 200 is for managing a free cache segment 325 stored in a FM chip 321, the RAM free queue 300 is for managing a free cache segment 343 of the RAM 34, and both are linked lists, which use a pointer to couple the SGCT 120 of the free cache segment. The FM free queue 200 and the RAM free queue 300 are the same configuration and only the managed SGCTs 120 differ. The free queue pointer 201 (301) of the FM free queue 200 (RAM free queue 300) points to the first SGCT 120 of the queue. An SGCT pointer 120a of the SGCT 120 points to the SGCT 120 of the next free cache segment.

The processing operations in the information system related to Example 1 will be explained next.

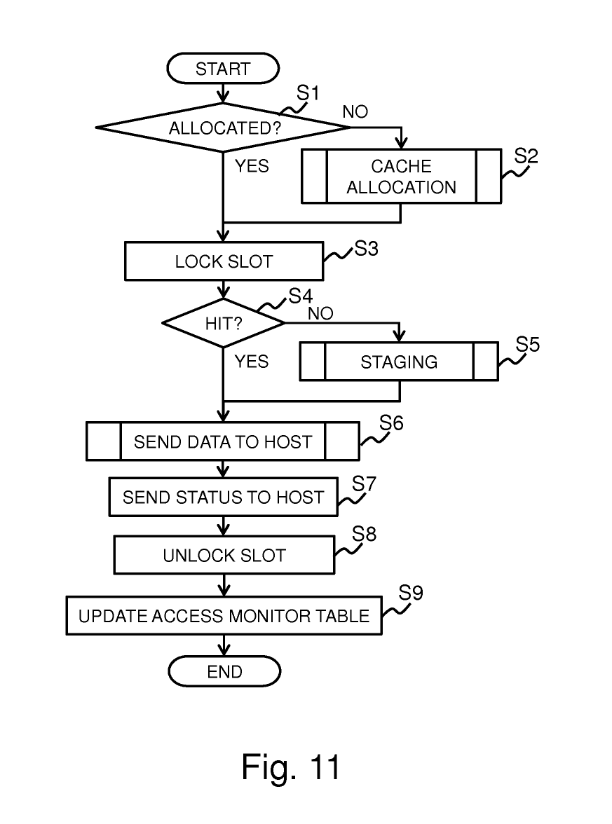

FIG. 11 is a flowchart of a read command process related to Example 1.

The read command process is executed in a case where the storage controller 30 has received a read command from the host computer 10.

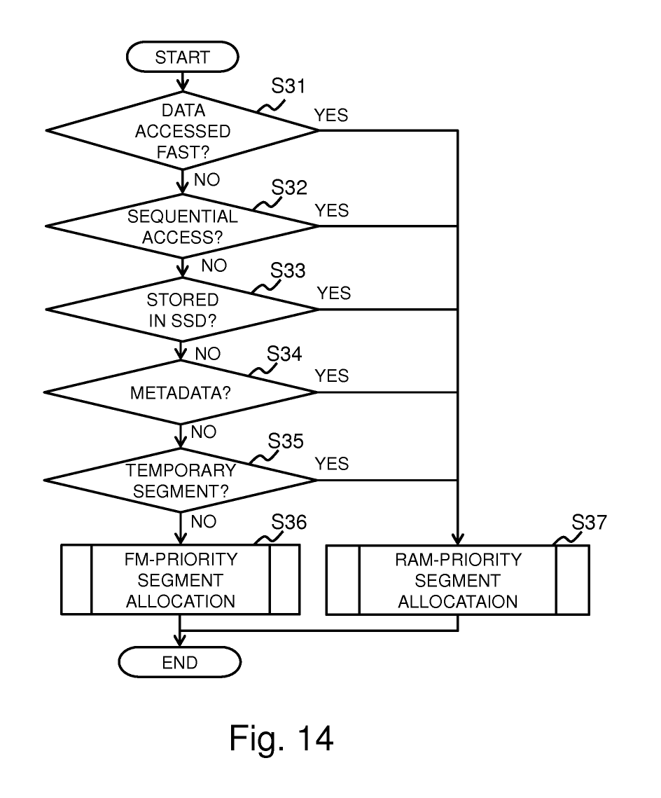

First, the CPU 33 of the storage controller 30, which received the read command, determines whether or not a cache segment corresponding to a logical block address of the read-target block on the logical volume (hereinafter referred to as “the read-target address”) specified in the read command has been allocated (Step S1). Specifically, as is explained earlier, the logical block address is transformed into a set of the slot ID and the in-slot relative address, and the CPU 33 refers to the SGCT pointer 110f in the SLCT 110 having the slot ID 110d obtained by the transformation. In a case where the SGCT pointer 110f is an invalid (for example, NULL) value, it is revealed that the cache segment is unallocated. In a case where a valid value is contained in the SGCT pointer 110f, it is revealed that at least one cache segment is allocated. Therefore, the CPU 33 confirms whether the cache segment is allocated in the position in the slot specified by the in-slot relative address, by following the SGCT pointer 110f. Specifically, it becomes possible to confirm whether the cache segment is allocated, by confirming whether there is the SGCT 120 having the segment ID 120b which is identical to a result (an integer) obtained by “the in-slot relative address divided by 128” (by performing the calculation of the in-slot relative address divided by 128, any one integer of 0 through 3 is obtained. Therefore, it becomes possible to find that the in-slot relative address is the address corresponding to the cache segment applied with any one segment ID of 0 through 3). In a case where the result is that a cache segment has been allocated (Step S1: YES), the CPU 33 advances the processing to Step S3, and alternatively, in a case where a cache segment has not been allocated (Step S1: NO), executes a cache allocation process (refer to FIG. 14) (Step S2) and advances the processing to Step S3. The details of the cache allocation process of Step S2 will be explained later. In the cache allocation process, process for allocating a cache segment of the FM chip 321 or a cache segment of the RAM 32, according to the access characteristics of the data cached, is performed.

In Step S3, the CPU 33 locks the slot comprising the cache segment, which corresponds to the read-target address. Specifically, the CPU 33 denotes that the relevant slot is locked by configuring the bit, which denotes that the slot status 110e of the SLCT 110 of the slot comprising this cache segment is “locked”, to ON.

Next, the CPU 33 determines whether or not the read-target data is stored in the cache segment, that is, whether or not there is a cache hit (Step S4). Specifically, the CPU 33 checks the staging bitmap 120e and the dirty bitmap 120f of the SGCT 120 corresponding to the read-target cache segment, and determines that there is a cache hit with respect to all of the logical blocks targeted by the read when either the bit of the staging bitmap 120e or the bit of the dirty bitmap 120f corresponding to the relevant logical block is ON. Alternatively, the CPU 33 determines that there is a cache miss when there is even one logical block for which any of the corresponding bits of the staging bitmap 120e and the dirty bitmap 120f is OFF within the range of the read target.

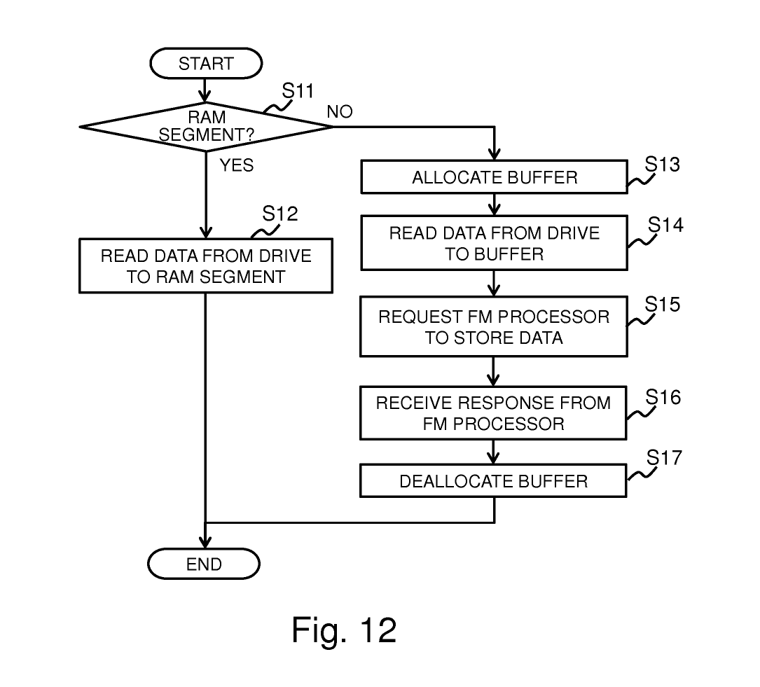

In a case where the result is a cache hit (Step S4: YES), the CPU 33 advances the processing to Step S6, and, alternatively, in the case of a cache miss (Step S4: NO), executes a staging process (refer to FIG. 12) (Step S5) and advances the processing to Step S6. In the staging process, data is read from a drive (either the HDD 40 or the SSD 41) to the cache segment (either 325 or 343). When the staging process is complete, the state is one in which the read-target data is stored in the cache segment (either 325 or 343).

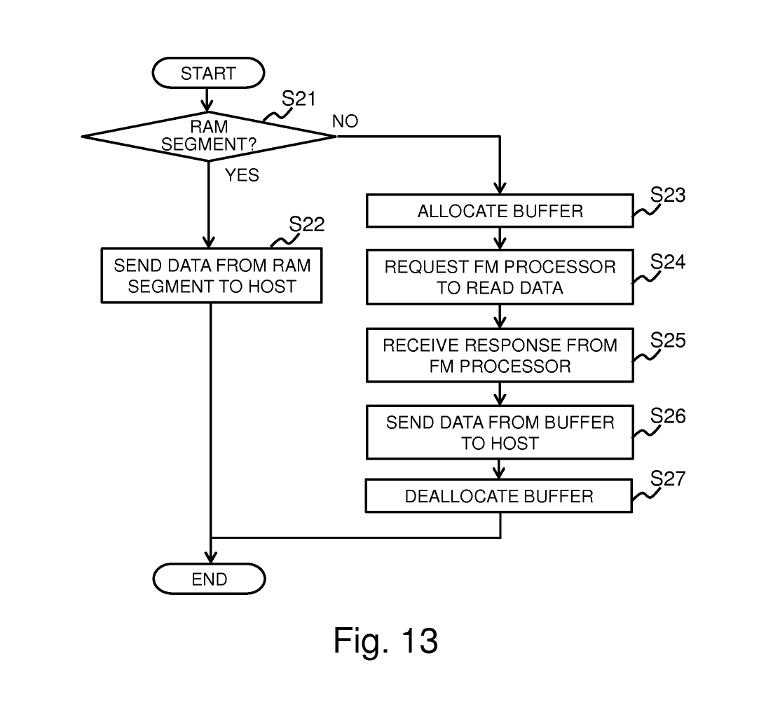

In Step S6, the CPU 33 executes a data send process (refer to FIG. 13) for sending the data stored in the cache segment to the host computer 10.

Next, the CPU 33 sends the status of the completed command to the host computer 10 (Step S7). That is, the CPU 33 returns an error status (for example, CHECK CONDITION) in a case where an error occurred during the processing of the command and the read process did not end normally, and, alternatively, returns a normal status (GOOD) in a case where the read process ended normally.

Next, the CPU 33 releases (unlocks) the locked slot (Step S8), updates the access monitor table 342 (Step S9), and ends the read command process. The updating of the access monitor table 342, for example, involves adding the bytes of data read in accordance with this read command to the read bytes counter 342e, and incrementing the read command counter 342g.

FIG. 12 is a flowchart of a staging process related to Example 1.

The staging process corresponds to the processing of Step S5 of the read command process of FIG. 11.

First, the CPU 33 checks the type of cache memory of the cache segment mapped to the read-target address, and determines whether or not the cache segment is a cache segment (a RAM segment) 343 on the RAM 34 (Step S11). Here, the type of the cache memory, which is the basis of the cache segment, can be identified by referencing the memory type 120c of the corresponding SGCT 120.

In a case where the result is that the cache segment is a RAM segment 343 (Step S11: YES), the CPU 33 advances the processing to Step S12, and, alternatively, in a case where the cache segment is not a RAM segment 343 (Step S11: NO), advances the processing to Step S13.

In Step S12, the CPU 33 reads the read-target (staging-target) data from the drive (either the HDD 40 or the SSD 41), stores the data in the RAM segment 343, and ends the staging process.

In the processing of Step S13 and beyond, since the cache segment is not a RAM segment 343, that is, since the cache segment is a cache segment (FM segment) 325 on the FM chip 321, the data read from the drive is not written directly to the FM chip 321, but rather is stored temporarily in the buffer memory 323 of the FM board 32, and thereafter, is written from the buffer memory 323 to the FM chip 321. This is to prevent a situation in which the throughput performance of the storage system 20 is lowered due to the fact that the write rate of the FM chip 321 is slow, and this rate acts as a drag slowing down the operation of the BE I/F 35 of the storage controller 30 when the data read from the drive is written directly to the FM chip 321. In this example, the BE I/F 35 receives an instruction from the CPU 33 and stores the data from the drive into the buffer memory 323 of the FM board 32. Therefore, the CPU 33 can execute another process after issuing the instruction to the BE I/F 35. The BE I/F 35, after storing the data from the drive to the buffer memory 323 of the FM board 32, is released from this processing and is able to execute another process.

First, in Step S13, the CPU 33 reserves an area (a buffer) for storing the data read from the drive in the buffer memory 323. That is, the CPU 33 allocates enough of the buffer memory 323 area to a buffer to store the staging-target data.

Next, the CPU 33 reads the staging-target data from the drive and stores this data in the buffer (Step S14). In this example, the BE I/F 35 receives the instruction from the CPU 33, and stores the data in the buffer of the buffer memory 323 of the FM board 32 from the drive.

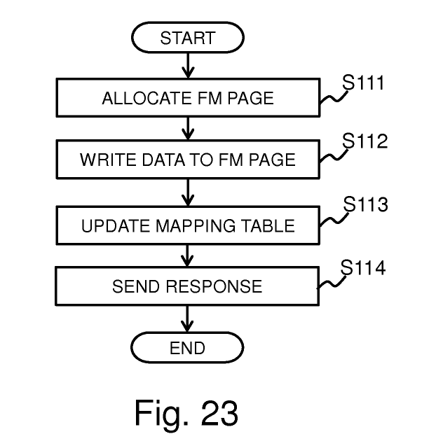

Then, the CPU 33 requests that the FM processor 320b store the data on the buffer of the buffer memory 323 in the FM chip 321 (Step S15). In response to the request, the FM processor 320b executes an FM data write process (refer to FIG. 23). The FM processor 320b, upon ending the FM data write process, returns a complete response to the CPU 33 with respect to the request.

Next, the CPU 33 receives the complete response with respect to the request from the FM processor 320b (Step S16), releases the buffer memory 323 buffer (Step S17), and ends the staging process.

FIG. 13 is a flowchart of a data send process related to Example 1.

The data send process corresponds to the processing of Step S6 of the read command process of FIG. 11.

In the data send process, in a case where the data is sent from the FM segment 325, the data is stored temporarily in the buffer memory 323, and the data is transferred from the buffer memory 323 to the host computer 10. This is to prevent a situation in which the throughput performance of the storage system 20 is lowered due to the fact that the read rate of the FM chip 321 is slow, and this rate acts as a drag slowing down the operation of the FE I/F 31 of the storage controller 30 when the data is directly transferred from the FM chip 321.

First, the CPU 33 checks the type of cache memory, which is serving as the basis of the cache segment mapped to the read-target address, and determines whether or not the cache segment is a RAM segment 343 (Step S21). Here, the type of the cache memory serving as the basis of the cache segment can be identified by referencing the memory type 120c of the corresponding SGCT 120.

In a case where the result is that the cache segment is a RAM segment 343 (Step S21: YES), the CPU 33 advances the processing to Step S22, and, alternatively, in a case where the cache segment is not a RAM segment 343 (Step S21: NO), advances the processing to Step S23.

In Step S22, the CPU 33 transfers the read-target (send-target) data from the RAM segment 343 to the host computer 10, and ends the data send process.

In Step S23, the CPU 33 reserves an area (buffer) in the buffer memory 323 for storing the send-target data read from the FM chip 321. That is, the CPU 33 allocates enough of the buffer memory 323 area to the buffer to store the send-target data.

Next, the CPU 33 requests that the FM processor 320b read the data on the FM chip 321 to the buffer memory 323 (Step S24). In response to the request, the FM processor 320b executes a FM data read process (Refer to FIG. 22). According to the FM data read process, the send-target data is stored in the buffer memory 323. The FM processor 320b, upon ending the FM data read process, returns a complete response to the CPU 33 with respect to the request.

Next, the CPU 33 receives the complete response with respect to the request from the FM processor 320b (Step S25), and sends the send-target data from the buffer memory 323 to the host computer 10 (Step S26). In this example, the FE I/F 31 receives an instruction from the CPU 33 (for example, the address of the buffer memory 323 of the data to be read), and sends the send-target data to the host computer 10 from the buffer of the buffer memory 323. Thereafter, the CPU 33 releases the buffer memory 323 buffer (Step S27) and ends the data send process.

FIG. 14 is a flowchart of a cache allocation process related to Example 1.

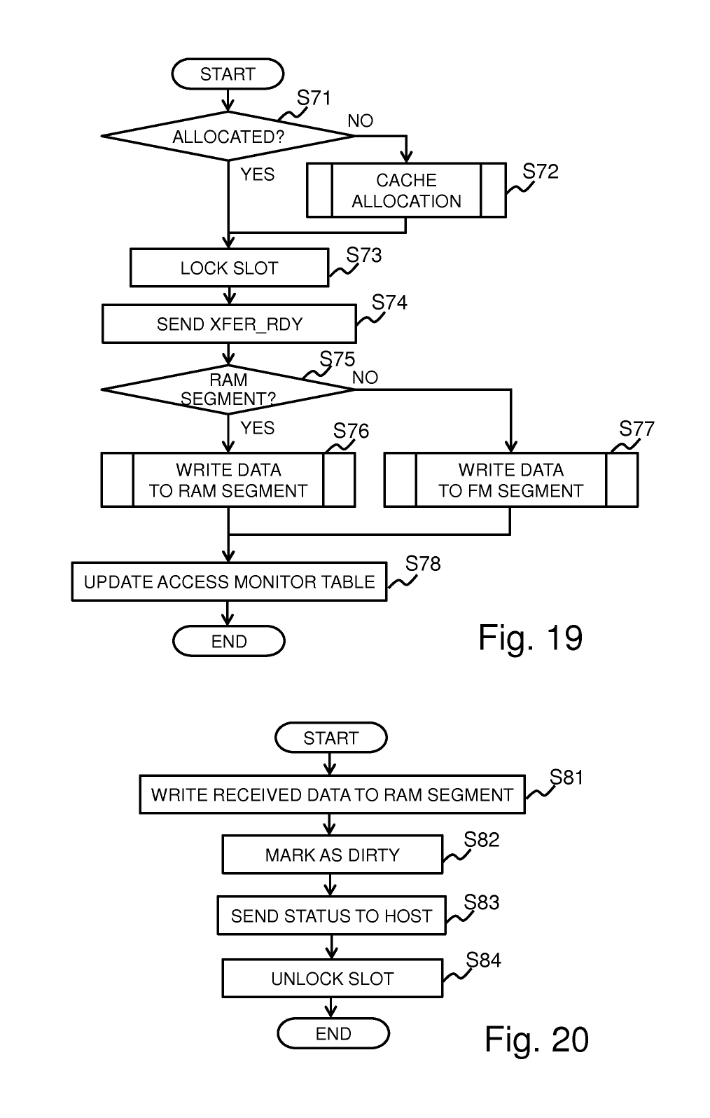

The cache allocation process corresponds to the processing of Step S2 of the read command process shown in FIG. 11, and the processing of Step S72 of the write command process shown in FIG. 19.

In the cache allocation process, the CPU 33 allocates either a cache segment of a FM chip 321 or a cache segment of the RAM 34 for the data to be cached in accordance with the access characteristics with respect to the relevant data.

First, the determination criteria when selecting the memory type of the cache segment to be allocated, that is, either the FM chip 321 or the RAM 34, will be explained here. At this point, since the FM chip 321 comprises characteristics such as (1) lower access performance than the RAM 34, and (2) an upper limit of the number of rewrites, in this example, the CPU 33 performs the control of selecting the cache segment using the RAM 34, for data in which the characteristics of the data relatively matches the characteristics of the RAM (required to have high performance, have high update frequency of the cache segment), and selecting the cache segment using the FM chip 321, for data matching the characteristics of the flash memory (less request to have high performance, not so high update frequency of the cache segment). Specifically, the CPU 33 selects the memory type of the cache segment to be allocated in accordance with the following criteria.

(a) In the case of data for which the access frequency (the read frequency/the write frequency) is high and data for which high throughput is required, the CPU 33 preferentially selects the RAM 34. Especially, if the data with high access frequency is stored to the cache segment of the FM chip 321, the access frequency of the FM chip 321 increases. In a case where the access frequency is high, the CPU 33 should preferentially select the RAM 34, since rewriting the data occurs frequently and causing the shortening of the life of the FM chip 321. This makes it possible to appropriately suppress the shortening of the life of the FM chip 321. Data requiring high throughput, for example, corresponds to a large read data for using in an in-memory database. Since data of this use are generally often data having a long transfer length or sequentially accessed data, the CPU 33 preferentially select the RAM 34 to the data determined as having the long transfer length. This makes it possible to realize high throughput.
(b) In the case of data for which a cache hit does not have much effect performance-wise when the data is cached in the FM chip 321, the CPU 33 preferentially selects the RAM 34. As data for which a cache hit does not have much effect performance-wise, for example, there is data, which is stored in the SSD 41. In accordance with preferentially selecting the RAM 34, the effects of a cache hit can be appropriately achieved.
(c) In a case where data having a small access unit is the target of a cache, the CPU 33 preferentially selects the RAM 34. This is because the size of the read/write unit (page) in the FM chip 321 is large compared to a minimum access unit of the RAM 34 (for example, 8 KB), making the referencing and updating of data in small units inefficient. For example, in case of metadata such as the control information, since the size of the metadata is usually size of 16 B and is smaller than the size of read/write unit of FM chip 321, the CPU 33 may preferentially select the RAM 34.
(d) In a case where data, which is to be immediately discarded from the cache, is the cache target, the CPU 33 preferentially selects the RAM 34. The reasons for this are that an erase occurs immediately in a FM chip 321 pursuant to discarding, and in a case where the data is to be discarded immediately, caching this data in the RAM 34 has only a temporary effect on capacity consumption. A policy for what kind of data is to be immediately discarded is configured as policy of the storage system. For example the data, which is stored in a temporary cache segment allocated for data copy, is discarded from the cache after completion of the copy processing. As another example, there are data for which a sequential read is performed and data for which a sequential write is performed. Regarding data for which a sequential read is performed, the data is read sequentially from the beginning, and basically, the same data is not read again right away when the read has ended. As for data for which a sequential write is performed, for example, in a case where the relevant data is stored in a RAID, the data is destaged at the point in time at which the required parity has been compiled, and is discarded from the cache thereafter.
(e) In a case where data, which conforms to a condition other than (a) through (d) above, is the cache target, the CPU 33 preferentially selects the FM chip 321.

A cache allocation process, which performs a cache allocation based on the criteria described hereinabove will be explained next by referring to FIG. 14.

First, the CPU 33 determines whether or not the access-target (either the read-target or the write-target) data is accessed fast (Step S31). Specifically, the CPU 33, for example, determines whether or not the access-target data is accessed fast based on a pre-determined access rate threshold with the read rate 342a or the write rate 342b of the area to which the access-target data recorded in the access monitor table 342 is stored. The calculation method of the read rate 342a or the write rate 342b will be explained later. In a case where the data access frequency is high, or in a case of data with long transfer length, the read rate 342a or the write rate 342b tabulated in the present embodiment becomes higher, so that it is possible to determine whether it is the data with high access frequency or the data with long transfer length, by comparing the read rate 342a or the write rate 342b of the data with a threshold. Alternatively, as another embodiment, the determination may be made by comparing the access frequency (the read frequency 342c or the write frequency 342d of the area to which the access-target data is stored, that are recorded in the access monitor table 342) with a threshold. When the result of determination in Step S31 is true (Step S31: YES), the CPU 33 advances the processing to Step S37, and, alternatively, when the result is false (Step S31: NO), advances the processing to Step S32.

In Step S32, the CPU 33 determines whether or not the access pattern with respect to the access-target data is sequential access. This determination can be realized in accordance with the CPU 33 determining whether or not the processing-target read command is part of a series of commands for reading consecutive addresses in sequence. Specifically, the CPU 33, for example, determines whether or not the access pattern is a sequential access in accordance with determining whether or not an address, which adds the transfer length of the relevant command to the target address of the previous read command, is the target address of this read command. In a case where the result is that the access pattern is determined to be a sequential access (Step S32: YES), the CPU 33 advances the processing to Step S37, and, alternatively, in a case where the result of the determination is false (Step S32: NO), the CPU 33 advances the processing to Step S33.

In Step S33, the CPU 33 determines whether or not the access-target data is data, which is ultimately to be stored in the SSD 41, that is, whether or not the final storage device of the access-target data is the SSD 41. The determination here as to whether or not the final storage device of the access-target data is the SSD 41, for example, can be realized in accordance with identifying the device type corresponding to the logical volume specified by the read command based on pre-stored information denoting the correspondence relationship between the logical volume and the device. In a case where the logical volume conforms to thin provisioning, whether or not the final storage device of the access-target data is the SSD 41 can be determined in accordance with identifying the device type of the device, which provides the real page being allocated to the logical volume. When the result is true (Step S33: YES), the CPU 33 advances the processing to Step S37, and, alternatively, when the result is false, advances the processing to Step S34.

In Step S34, the CPU 33 determines whether or not the access-target data is metadata. As used here, metadata comprises control information, which either was saved and stored, or is to be saved and stored in the drive (40, 41) from the storage controller 30 RAM 34. Whether or not the access-target data is metadata, for example, can be determined here in accordance with whether or not the access destination is a prescribed region in which control information is stored in the logical volume. The address of the region in which the control information is stored in the logical volume can be acquired from the host computer 10 using the logical volume. When the result is true (Step S34: YES), the CPU 33 advances the processing to Step S37, and, alternatively, when the result is false, advances the processing to Step S35.

In Step S35, the CPU 33 determines whether or not the cache segment corresponding to the access-target data is a temporary cache segment (temporary segment). The temporary segment here is any of the following.

(1) A segment allocated for storing old data or an old parity in a case where the relevant old data or old parity resulted in a cache miss at parity creation.
(2) A segment temporarily allocated for a process for copying drive (for example, the final storage device) data.
(3) A segment temporarily allocated for a process (for example, for a remote copy process) for exchanging data with another storage apparatus.

The CPU 33, when allocating a cache segment for data, may receive from the host computer 10 information showing whether or not high throughput is required or information showing I/O priority, store information showing whether or not high throughput is required or information showing I/O priority by associating this information with the cache segment, and determine whether or not the cache segment is a temporary cache segment based on this information.

When the result is true (Step S35: YES), the CPU 33 advances the processing to Step S37, and, alternatively, when the result is false, advances the processing to Step S36.

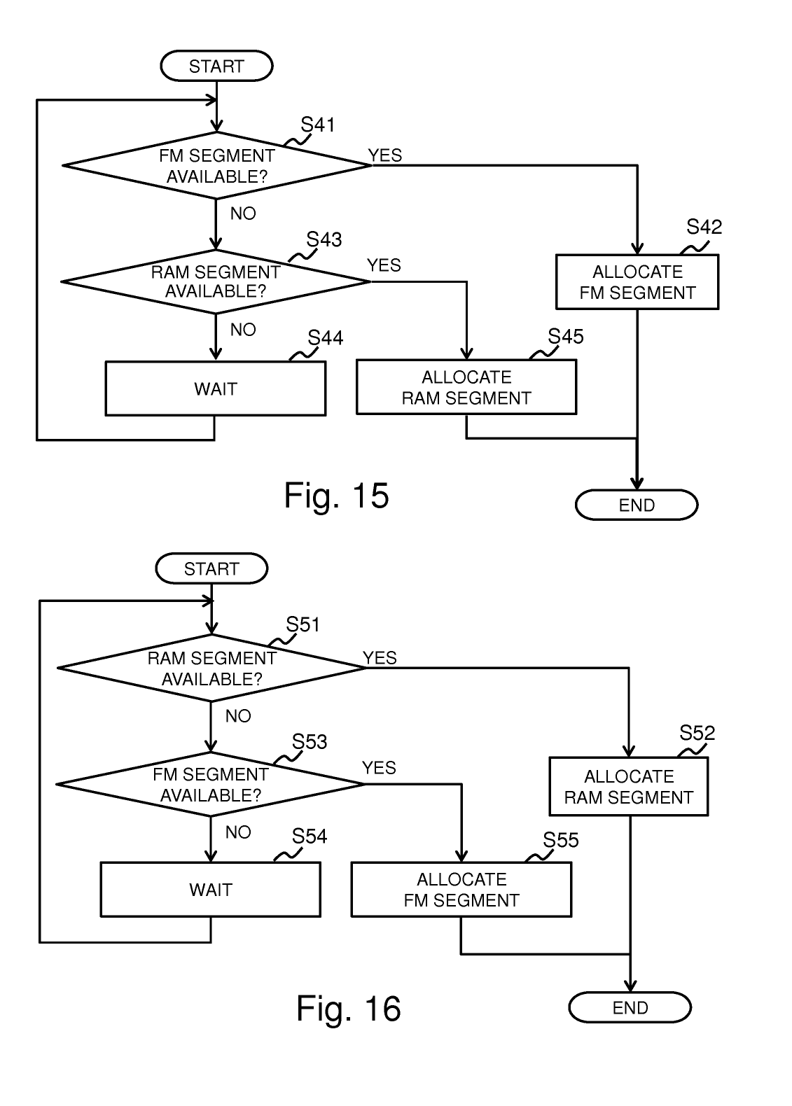

In Step S36, the CPU 33 executes an FM-priority segment allocation process (refer to FIG. 15) for preferentially allocating a cache segment 325 of the FM chip 321, and ends the cache allocation process.

In Step S37, the CPU 33 executes a RAM-priority segment allocation process (refer to FIG. 16) for preferentially allocating a cache segment 343 of the RAM 34, and ends the cache allocation process.

When the cache allocation process is complete, a cache segment from either one of the FM chip 321 or the RAM 34 is allocated for the access-target data.

FIG. 15 is a flowchart of a FM-priority segment allocation process related to Example 1.

The FM-priority segment allocation process corresponds to Step S36 of the cache allocation process shown in FIG. 14.

First, the CPU 33 determines whether or not a FM segment 325 is available (Step S41). An available FM segment 325 is a cache segment 325, which is either free, or clean and unlocked. Whether a FM segment 325 is available or not can be determined in accordance with referencing the cache management data structure. When the determination result is true (Step S41: YES), the CPU 33 advances the processing to Step S42, and, alternatively, when the determination result is false (Step S41: NO), advances the processing to Step S43.

In Step S42, the CPU 33 performs a FM segment allocation process. When allocating a clean cache segment here, the CPU 33 performs the FM segment allocation process after separating the relevant cache segment from the clean queue and the cache directory 100 and treating the relevant cache segment as a free segment.

In the FM segment allocation process, first, the CPU 33 sets a segment ID 120b and a memory type 120c (FM) corresponding to a cache segment reserved in the SGCT 120. Then the CPU 33 sets a pointer to the SGCT 120 of the relevant cache segment in the SGCT pointer 110f of the SLCT 110, which corresponds to the slot comprising this cache segment. In a case where the corresponding SLCT 110 is not coupled to the cache directory 100, after configuring the contents of the SLCT 110, the CPU 33 first couples the relevant SLCT 110 to the cache directory 100, and thereafter couples the SGCT 120 to the SLCT 110. In a case where a SGCT 120 other than the SGCT 120 corresponding to the reserved cache segment is already coupled to the SLCT 110, the CPU 33 couples the SGCT 120 of the reserved cache segment to the terminal SGCT 120 coupled to this SLCT 110. After the FM segment allocation process has ended, the CPU 33 ends the FM-priority segment allocation process.

In Step S43, the CPU 33 determines whether or not a RAM segment 343 is available. When the determination result is true (Step S43: YES), the CPU 33 advances the processing to Step S45, and, alternatively, when the determination result is false (Step S43: NO), waits until any of the cache segments becomes available (Step S44) and moves the processing to Step S41.

In Step S45, the CPU 33 performs a RAM segment allocation process. The RAM segment allocation process is for allocating a RAM segment 343 in the FM segment allocation process in place of the FM segment 325, which would have been allocated in Step S42. After the RAM segment allocation process has ended, the CPU 33 ends the FM-priority segment allocation process.

In this FM-priority segment allocation process, priority is placed on allocating a FM segment 325.

FIG. 16 is a flowchart of a RAM-priority segment allocation process related to Example 1.

The RAM-priority segment allocation process corresponds to Step S37 of the cache allocation process shown in FIG. 14.

The RAM-priority segment allocation process is processing in which the FM segment in the FM-priority segment allocation process shown in FIG. 15 is replaced with a RAM segment, and as such, a simplified explanation will be given here.

First, the CPU 33 determines whether or not a RAM segment 343 is available (Step S51). When the determination result is true (Step S51: YES), the CPU 33 advances the processing to Step S52, and, alternatively, when the determination result is false (Step S51: NO), advances the processing to Step S53.

In Step S52, the CPU 33 performs a RAM segment allocation process. The RAM segment allocation process is the same process as that of Step S45 of FIG. 15. After the RAM segment allocation process has ended, the CPU 33 ends the RAM-priority segment allocation process.

In Step S53, the CPU 33 determines whether or not a FM segment 325 is available. When the determination result is true (Step S53: YES), the CPU 33 advances the processing to Step S55, and, alternatively, when the determination result is false (Step S53: NO), waits until any of the cache segments becomes available (Step S54) and moves the processing to Step S51.

In Step S55, the CPU 33 performs a FM segment allocation process. The FM segment allocation process is the same process as that of Step S42 of FIG. 15. After the FM segment allocation process has ended, the CPU 33 ends the RAM-priority segment allocation process.

In the RAM-priority segment allocation process, priority is given to the allocation of a RAM segment 343.

FIG. 17 is a flowchart of an access monitor tabulation process related to Example 1.

The access monitor tabulation process, for example, is executed on a fixed time cycle, and is a process for tabulating the read and write bytes and read and write frequencies during this period, and updating the access monitor table 342.

First, the CPU 33 updates the read rate 342a of the access monitor table 342 (Step S61). That is, the CPU 33 sets a value, which is obtained by dividing the read bytes counter 342e value by the time from the monitor start time 342i to the present (hereinafter, called monitor time), in the read rate 342a of the access monitor table 342 as the read rate.

Next, the CPU 33 updates the write rate 342b of the access monitor table 342 (Step S62). That is, the CPU 33 sets a value, which is obtained by dividing the written bytes counter 342f value by the monitor time, in the write rate 342b of the access monitor table 342 as the write rate.

Next, the CPU 33 updates the read frequency 342c of the access monitor table 342 (Step S63). That is, the CPU 33 sets a value, which is obtained by dividing the read command counter 342g value by the monitor time, in the read frequency 342c of the access monitor table 342 as the read frequency.

Next, the CPU 33 updates the write frequency 342d of the access monitor table 342 (Step S64). That is, the CPU 33 sets a value, which is obtained by dividing the write command counter 342h value by the monitor time, in the write frequency 342d of the access monitor table 342 as the write frequency.

Then, the CPU 33 sets the present time in the monitor start time 342i of the access monitor table 342 (Step S65), resets the values of the read bytes counter 342e, the written bytes counter 342f, the read command counter 342g, and the write command counter 342h to 0 (Step S66) and ends the access monitor tabulation process.

According to the access monitor tabulation process, it is possible to appropriately discern the read rate, the write rate, the read frequency, and the write frequency for each partial region inside the logical unit.

In the access monitor tabulation process explained above, the read rate and the write rate are calculated by dividing the read bytes and the write bytes by the monitor time. However, as another embodiment, it is possible to make the access monitor table 342 stores an accumulation of a process time of the read commands and the write commands (a time spent from receiving the command until replying a response to the host computer 10), and divide the read bytes and the write bytes respectively by the accumulation of the process time of the read commands and the write commands. Assuming a case where the commands (the read or the write commands) are issued a plurality of times to a certain partial region in the logical unit, when the access speed is calculated by dividing the read bytes or the write bytes by the monitor time, the calculated access speed becomes slower, in a case where a time interval between the issued commands is long, even when it is an access to the data with long transfer lengths. When values obtained by dividing the read bytes and the write bytes respectively by the accumulation of the process time of the read commands and the write commands are referred to as the read rate and the write rate, then the calculated read rate and the write rate becomes higher in a case of the access to the data with long transfer length, regardless of the time interval between the commands issued with respect to the certain partial region in the logical unit. Therefore, in a case where it is desirable to cache the data preferentially to the RAM in a case of the access to the data with long transfer length, regardless of the length of the time interval of the commands issued with respect to the certain partial region in the logical unit, the values obtained by dividing the read bytes and the write bytes respectively by the accumulation of the process time of the read commands and the write commands should be set as the read rate and the write rate.

Here, the access monitor table 342 is set for each partial region in the logical unit, and the access frequency and the access rate are tabulated for each partial region. The size of the partial region (that is, a unit in which the access frequency and the access rate are accumulated in one access monitor table 342) may be various sizes, as is explained earlier. In the storage system of the present invention, the memory type to be allocated as the cache segment is determined on the basis of the information of the access monitor table 342. When determining the memory type to be allocated as the cache segment, the process in FIG. 14 and the like performs determination in the cache segment units, so that the memory type to be allocated is determined for the partial region units. Therefore, in a case where the type of the cache memory to be allocated should be selected for smallest possible region, it is preferable to set the size of the partial region small. For example, if the size of the partial region is the same size as the cache segment, then it becomes possible to allocate the memory according to the access characteristics of each cache segment. However, if the size of the partial region is small, the amount of the access monitor table 342 that must be maintained and managed increases. Therefore, the size of the partial region may be an integral multiple of the cache segment size (for example, a size of the slot), or an integral multiple of the slot size.

Further, the access monitor table 342 and the access monitor tabulation process in Example 1 is provided exclusively for performing the cache allocation process. However, as another embodiment, in a case where a means for tabulating information such as the access frequency of the partial region of the logical volume exists, for purposes other than the cache allocation process, then the information tabulated by the means may be used. For example, US Patent Application Publication No. 2013/0036250 and US Patent Application Publication No. 2010/0205390 disclose that a storage device providing a logical volume accompanying a so-called thin provisioning includes a function of tabulating the access frequency and the like for each partial region (which is called a page), in order to determine the storage area to be allocated to each page of the logical volume. In a case where the storage system 20 according to the examples of the present invention is configured to have such function, then the determination of the cache allocation may be performed, using the access frequency information tabulated for each table, instead of the access monitor table 342 and the access monitor tabulation process explained above.

FIG. 18 is a drawing illustrating a determination threshold calculation method related to Example 1.

In Step S31 of the cache allocation process shown in FIG. 14, the threshold, which serves as a reference when determining whether or not the target data is accessed fast, is desirably set to a value which does not make the life of the FM chip 321 used in the FM board excessively short, that is, which does not make the update/erase frequency with respect to the FM chip 321 excessively high. As such, the threshold is decided by taking into consideration the number of times rewriting is possible in and the capacity of the FM chip 321 to be used and the performance of the storage system 20 (for example, a write frequency from the host computer 10), and the like. The threshold may be a predetermined fixed value, but may also be dynamically decided using the values of the access monitor table 342 as described hereinbelow. In so doing, it is possible to configure a threshold that better fits the situation.

First, the CPU 33 sorts respective regions (partial regions) having write rates in order from the slowest to the fastest write rate as shown in the graph on the left side of FIG. 18 to achieve results like those shown in the graph on the right side of FIG. 18. Each region here is the partial region managed by the access monitor table 342. Then, the CPU 33 adds the write rate of each region in order, and when the total exceeds a permissible total write rate determined using Equation (1), treats the write rate of the relevant region as the threshold to be used as a reference when determining whether or not the target data is accessed fast. That is, a region for which the write rate is less than the relevant region write rate is the region (FM appropriate region) suitable for caching in the FM chip 321, and the CPU 33 caches this region in the FM chip 321, and does not cache the other region in the FM chip 321.

Permissible total write rate=remaining writable bytes/(remaining usage period×margin)−other FM update rate (1)

The remaining writable bytes here are decided in accordance with the remaining number of times rewriting is possible for and the capacity of the FM chip 321 and a WA (Write Amplification: an index denoting how many times the bytes written to a flash memory are amplified by reclamation and wear leveling). The other FM update rate is the rate at which the FM chip 321 is updated in accordance with a process other than a write from the host computer 10, for example, a cache replacement or a destage. The remaining usage period is equivalent to the period up to the date on which it is assumed the FM chip 321 will be replaced.

In the information system, in a case where the remaining writable bytes of the FM chip 321 have dwindled, it is possible to stop a cache allocation to the FM board 32 on which the FM chip 321 is mounted, and to replace the FM board 32 with a new FM board 32. For example, in a case where the remaining writable bytes of the FM chip 321 fall below a predetermined threshold, the CPU 33 sets the permissible total write rate to 0. In so doing, the allocation of a FM segment will not be performed. In addition, the CPU 33 lets the administrator know that the FM board 32 needs to be replaced using methods such as displaying a message on a management terminal and sending an e-mail to the administrator urging the replacement of the FM board 32.

At FM board 32 replacement, first the CPU 33, after writing the dirty data remaining in the old FM board 32 to the drive, for example, displays on the management terminal a notification to the effect that the old FM board 32 can be removed. After the administrator has removed the old FM board 32 from the storage controller 30 and inserted a new FM board 32 into the storage controller 30, the CPU 33 initializes the new FM board 32, initializes the remaining writable bytes, and computes the permissible total write rate the same as was described hereinabove. In accordance with this, FM segment allocation is performed using the new FM board 32 thereafter.

FIG. 19 is a flowchart of a write command process related to Example 1.

The write command process is executed in a case where the storage controller 30 has received a write command from the host computer 10.

First, the CPU 33 of the storage controller 30, which has received the write command, determines whether or not a cache segment mapped to the logical block address of the logical volume of the write-target (the write-target address) specified in the write command has been allocated (Step S71). Since this processing is similar to the read process (S1 in FIG. 11), detailed explanation thereof will be omitted. In a case where the result is that a cache segment has been allocated (Step S71: YES), the CPU 33 advances the processing to Step S73, and, alternatively, in a case where a cache segment has not been allocated (Step S71: NO), executes a cache allocation process (refer to FIG. 14) (Step S72) and advances the processing to Step S73. In the cache allocation process, a cache segment is allocated from either the RAM 34 or the FM chip 321 to the write-target address. Two cache segments may be allocated to ensure reliability by making the written data duplicate.

In Step S73, the CPU 33 locks the slot, which comprises the cache segment corresponding to the write-target address. Specifically, the CPU 33 denotes that the relevant slot is locked in accordance with configuring the bit, which denotes that the SLCT 110 slot status 110e of the slot comprising this cache segment is “locked”, to ON.

Next, the CPU 33 notifies the host computer 10, for example, that preparations for receiving data have been made by sending XFER_RDY (Step S74).

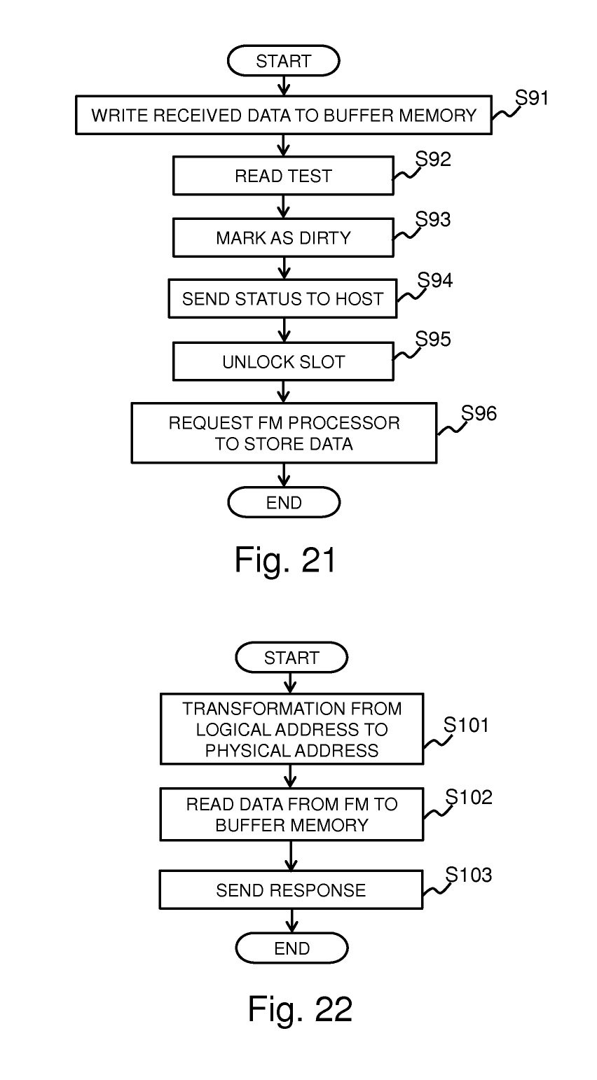

Then, the CPU 33 determines whether or not the allocated cache segment is a RAM segment 343 (Step S75). In a case where the result is that the allocated cache segment is a RAM segment 343 (Step S75: YES), the CPU 33 executes a data receive process (RAM) (refer to FIG. 20) for storing data, which has been received from the host computer 10 in the RAM segment 343 (Step S76), and advances the processing to Step S78. Alternatively, in a case where the allocated cache segment is a FM segment 325 (Step S75: NO), the CPU 33 executes a data receive process (FM) (refer to FIG. 21) for storing the data received from the host computer 10 in the FM segment 325 (Step S77) and advances the processing to Step S78.

In Step S78, the CPU 33 updates the access monitor table 342. That is, the CPU 33 adds the data bytes received in accordance with this write command to the written bytes counter 342f of the access monitor table 342, and increments the write command counter 342h. Thereafter, the CPU 33 ends the write command process.

FIG. 20 is a flowchart of a data receive process (RAM) related to Example 1.

The data receive process (RAM) corresponds to the processing of Step S76 of the write command process shown in FIG. 19.

First, the CPU 33 writes data, which has been received from the host computer 10, to a RAM segment 343 (Step S81).

Next, the CPU 33 sets the written data as dirty data (Step S82). That is, the CPU 33 sets the bit, which corresponds to the block into which the received data has been written, to ON in the dirty bitmap 120f of the SGCT 120.

Next, the CPU 33 sends the status of the completed command to the host computer 10, releases (unlocks) the slot comprising the RAM segment 343 (Step S84), and ends the data receive process (RAM).

FIG. 21 is a flowchart of a data receive process (FM) related to Example 1.

The data receive process (FM) corresponds to the processing of Step S77 of the write command process shown in FIG. 19.

First, the CPU 33 write data, which has been received from the host computer 10, to the buffer memory 323 of the FM board 32 (Step S91).

Next, the CPU 33 tests whether the written data can be read from the buffer memory 323 (Step S92). At this time, the CPU 33, for example, may confirm that the data is normal in accordance with checking a guarantee code, such as a CRC (Cyclic Redundancy Check), which has been added to the data.

Next, the CPU 33 sets the written data to dirty data (Step S93). That is, the CPU 33 sets the bit, which corresponds to the block into which the received data has been written, to ON in the dirty bitmap 120f of the SGCT 120.

Next, the CPU 33 sends the status of the completed command to the host computer 10, and releases the slot comprising the FM cache segment 325 (Step S95).

Next, the CPU 33 request that the FM processor 302b store the data on the buffer memory 323 in the cache segment 325 of the FM chip 321 (Step S96), and ends the data receive process (FM).

FIG. 22 is a flowchart of a FM data read process related to Example 1.

The FM data read process is executed in a case where the FM processor 320b has received a request to read data on the FM chip 321 to the buffer in Step S24 of the data send process shown in FIG. 13.

First, the FM processor 320b transforms the logical address specified from the CPU 33 of the storage controller 30 to a physical address denoting a data storage location on the FM chip 321 (Step S101). The transformation from the logical address to the physical address can be performed based on a mapping table showing the correspondence relationship between the logical address and the physical address. The mapping table is stored in the buffer memory 323.

Next, the FM processor 320b reads the target data from the region corresponding to the physical address of the FM chip 321, and stores this target data in the buffer memory 323 (Step S102).

Then, the FM processor 320b sends a complete response to the CPU 33 of the storage controller 30 (Step S103), and ends the FM data read process.

FIG. 23 is a flowchart of a FM data write process related to Example 1.

The FM data write process is executed in a case where the FM processor 320b has received a request to store data on the buffer memory 323 in the cache segment 325 of the FM chip 321 in Step S96 of the data receive process (FM) shown in FIG. 21.

First, the FM processor 320b reserves a page (also referred to as FM page) of the data storage destination FM chip 321 (Step S111). Since the FM chip 321 is not able to overwrite data on the same page, the FM processor 320b selects an already erased FM page here as the data storage destination. In a case where an erased FM page does not exist, the FM processor 320b erases a free block of the FM chip 321 (also referred to as free FM block), that is, a block (also referred to as a FM block) in which valid data is not being stored, and selects an FM page of the required bytes from the beginning of this FM block as the data storage destination.

Next, the FM processor 320b writes the data on the buffer memory 323 to the reserved FM page (Step S112).

Then, the FM processor 320b updates the mapping table denoting the relationship between the logical address and the physical address so that the logical address, which is the target of the processing this time, corresponds to the FM page physical address where the new data has been stored, and, in addition, stores the fact that the FM page in which the old data is being stored is invalid (Step S113). In a case where all the FM pages of the FM block comprising the invalid FM page are invalid at this time, the FM processor 320b manages the relevant FM block as a free FM block. The data of the free FM block may be erased at this point in time, or the free FM block data may be erased later as a background process.

Then, the FM processor 320b sends a complete response to the CPU 33 of the storage controller 30 (Step S114), and ends the FM data write process.

### Example 2

An information system related to Example 2 will be explained next. In so doing, the points of difference with at least one of the examples of the examples described hereinabove will mainly be explained, and the explanation of the points in common with at least one of the examples of the examples described hereinabove will be simplified or omitted. This is not limited to Example 2, but rather will be the same for Example 3 and the examples that follow.

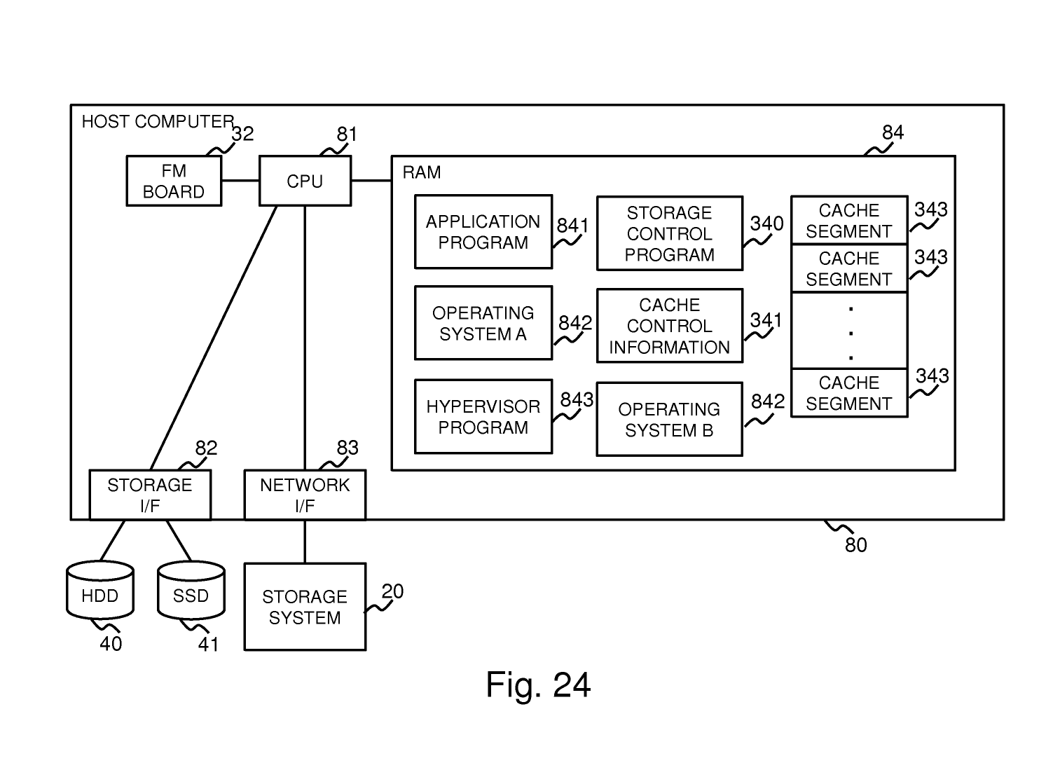

FIG. 24 is a block diagram of an information system related to Example 2. The same reference signs will be assigned to configurations that are the same as those of the information system related to Example 1.

The main difference between the information system related to Example 2 and the information system related to Example 1 is that the FM board 32 is mounted in a host computer 80. This host computer 80 is an example of an information processing apparatus.

The information system related to Example 2 comprises the host computer 80, and a HDD 40, a SSD 41 or a storage system 20 coupled to the host computer 80 either directly or via a network.

The host computer 80 comprises a CPU 81, a RAM 84, a FM board 32, a storage interface 82, and a network interface 83.

The storage interface 82 is an interface for coupling either the HDD 40 or the SSD 41. The network interface 83 is an interface for coupling the storage system 20 via a network. The FM board 32 is the same configuration as the FM board related to Example 1 shown in FIG. 4.

The RAM 84 stores an application program 841, operating systems 842 (operating system A and operating system B), a hypervisor program 843, and a storage control program 340 executed by the CPU 81, and cache control information 341. The RAM 84 also stores a cache segment 343 for caching data.

The hypervisor program 843 manages a virtual machine (VM) constructed by the host computer 80. The function of the hypervisor program 843 may also be implemented as hardware.

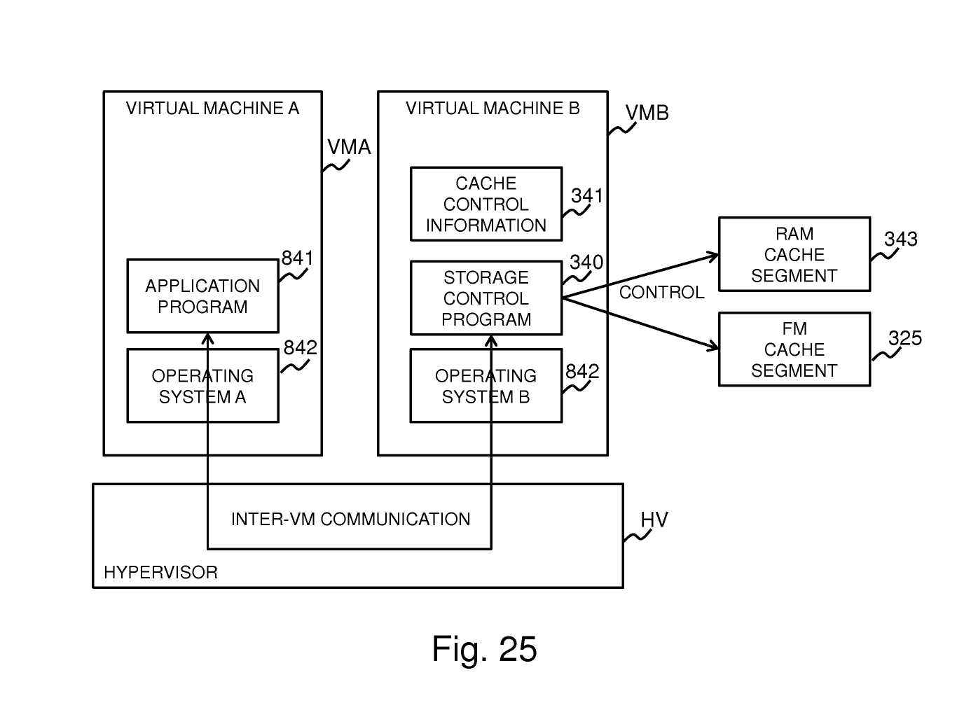

FIG. 25 is a drawing showing an overview of data input/output processing related to Example 2.

In the host computer 80 related to this example, a hypervisor HV, which is constructed in accordance with the CPU 81 executing the hypervisor program 843, is located in the bottom-most layer. The hypervisor HV is a type of virtual mechanism. A virtual mechanism may be a computer, which comprises a processor for executing a program. The hypervisor HV realizes one or more virtual machines (virtual machine A (VMA) and virtual machine B (VMB) in FIG. 25). The operating system A runs on the virtual machine A, and the application program 841 runs thereon. The operating system B runs on the virtual machine B, and the storage control program 340 runs thereon. The storage control program 340 uses the RAM 34 cache segment 343 and the FM chip 321 cache segment 325 to control the same caches as those of Example 1. The storage control program 340 also controls the input/output of data to/from the HDD 40, the SSD 41, or the storage system 20 coupled to the host computer 80.

The application program 841 of the virtual machine A and the storage control program 340 of the virtual machine B communicate with one another using inter-virtual machine communications. These inter-virtual machine communications are virtualized in accordance with either the hypervisor HV or the operation systems 842, and, for example, may be carried out for the application program 841 and the storage control program 340 using a virtual interface the same as in communications via a storage interface like SCSI.

According to the information system related to Example 2, data caching can be appropriately performed in the host computer 80 using the RAM cache segment 343 and the FM cache segment 325.

### Example 3

An information system related to Example 3 will be explained next.

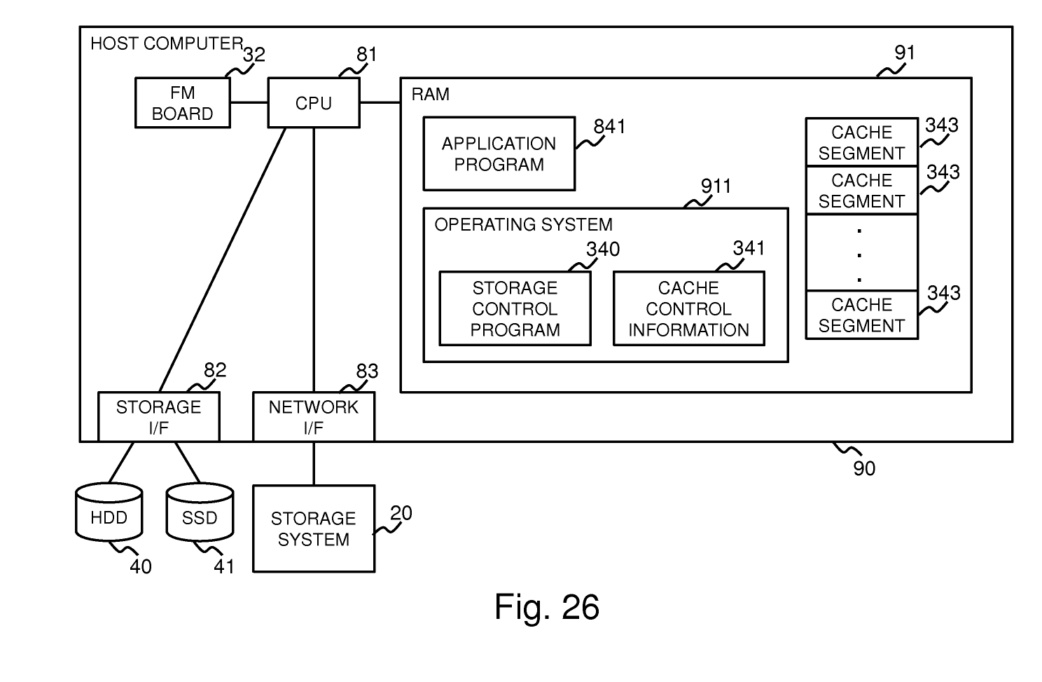

FIG. 26 is a drawing showing the configuration of an information system related to Example 3.

Regarding the information system related to Example 3, the contents managed by the RAM in the host computer differ from those of the information system related to Example 2.

A host computer 90 related to Example 3 comprises a RAM 91. This host computer 90 is an example of an information processing apparatus. The RAM 91 stores an operating system 911. The operating system 911 comprises a storage control program 340 and cache management information 341 as a driver.

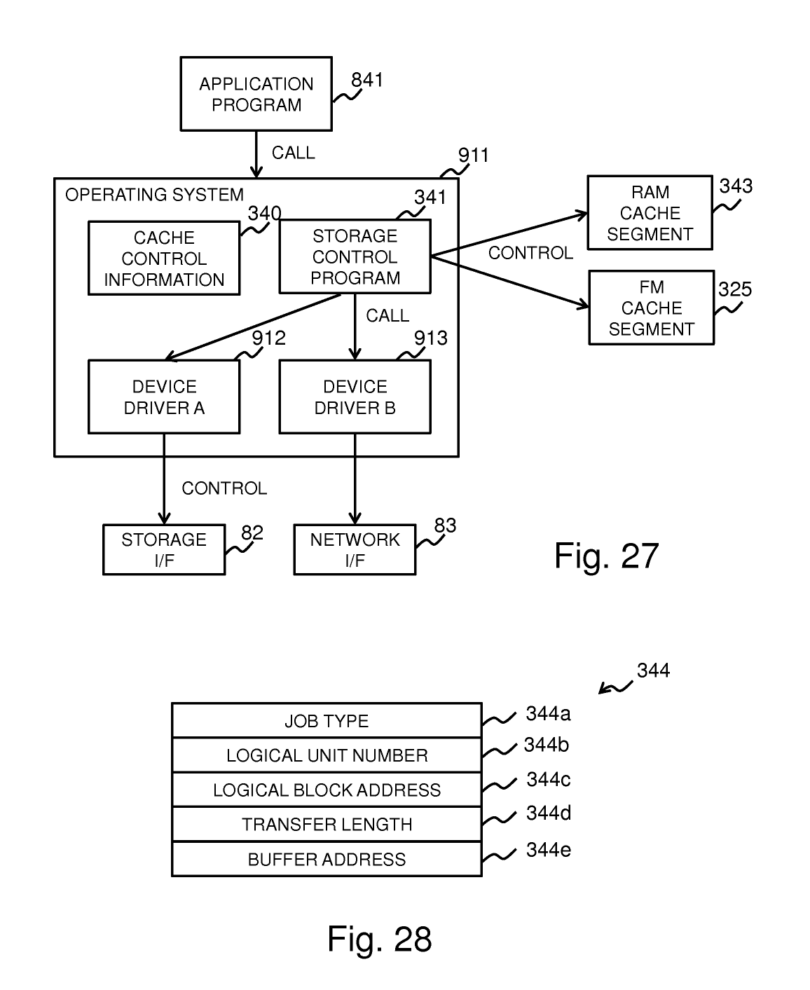

FIG. 27 is a drawing showing an overview of data input/output processing related to Example 3.

In the host computer 90 related to Example 3, when the application program 841 performs input/output to/from a storage (the HDD 40, the SSD 41, or the storage system 20); the storage control program 341 included in the operating system 911 processes this input/output request, and, the same as in Example 1, caching is performed to the RAM cache segment 343 or the FM cache segment 325. The storage control program 341 delivers the input/output request for the storage to various device drivers (912 and 913) in order to perform the input/output to/from the storage. The device driver A912 controls the storage interface 82 based on the input/output request. The device driver B913 controls the network interface 83 based on the input/output request.

According to the information system related to Example 3, the operating system 911 of the host computer 90 is able to appropriately perform data caching using the RAM cache segment 343 and the FM cache segment 325.

### Example 4

An information system related to Example 4 will be explained next.

The difference between the information system related to Example 4 and the information system related to Example 1 lies in the steps of the read command process. In the information system related to Example 4, prior to writing data, which has been staged from the drive, to the FM chip 321 from the buffer memory 323, the data is first sent from the buffer memory 323 to the host computer 10, and thereafter written to the FM chip 321. This makes it possible to shorten the required time (response time) until read command completion.

FIG. 28 is a block diagram of a job control table related to Example 4.

The job control table 344 stores a job type 344a, a logical unit number 344b, a logical block address 344c, a transfer length 344d, and a buffer address 344e. The job type 344a denotes the type of processing a job performs. The job type 344a, for example, is an ID showing “1” in the case of a read command process, and “2” in the case of a write command process. The logical unit number 344b, the logical block address 344c, and the transfer length 344d respectively denote the logical unit number, the logical block address (LBA), and the transfer length of an access target specified in a read/write command received from the host computer 10. The buffer address 344e denotes the address of the buffer reserved for this job. When a buffer has not been reserved, the buffer address 344e is a value (for example, NULL), which denotes that the address is invalid.

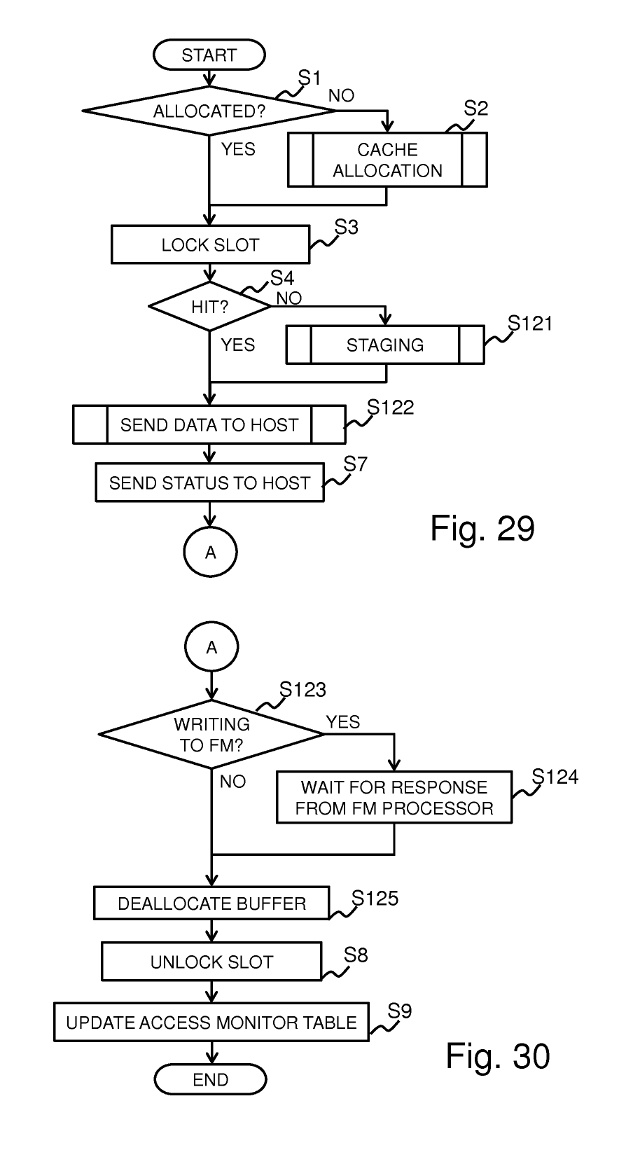

FIG. 29 is a first flowchart of a read command process related to Example 4, and FIG. 30 is a second flowchart of the read command process related to Example 4. The reference sign A of the FIG. 29 flowchart shows a link to the reference sign A of the FIG. 30 flowchart.

The read command process is executed in a case where the storage controller 30 has received a read command from the host computer 10.

First, the CPU 33 of the storage controller 30, which received the read command, determines whether or not a cache segment corresponding to the read-target address specified in the read command has been allocated (Step S1). In a case where the result is that a cache segment has been allocated (Step S1: YES), the CPU 33 advances the processing to Step S3, and alternatively, in a case where a cache segment has not been allocated (Step S1: NO), executes a cache allocation process (refer to FIG. 14) (Step S2) and advances the processing to Step S3. The cache allocation process is as was explained in Example 1.

In Step S3, the CPU 33 locks the slot comprising the cache segment, which corresponds to the read-target address. Specifically, the CPU 33 denotes that the relevant slot is locked by configuring the bit, which denotes that the slot status 110e of the SLCT 110 of the slot comprising this cache segment is “locked”, to ON.

Next, the CPU 33 determines whether or not the read-target data is stored in the cache segment, that is, whether or not there is a cache hit (Step S4). Specifically, the CPU 33 checks the staging bitmap 120e and the dirty bitmap 120f of the SGCT 120 corresponding to the read-target cache segment, and determines that there is a cache hit with respect to all of the logical blocks targeted by the read when either the bit of the staging bitmap 120e or the bit of the dirty bitmap 120f corresponding to the relevant logical block is ON. Alternatively, the CPU 33 determines that there is a cache miss when there is even one logical block for which any of the bits corresponding to the staging bitmap 120e and the dirty bitmap 120f is OFF within the range of the read target.

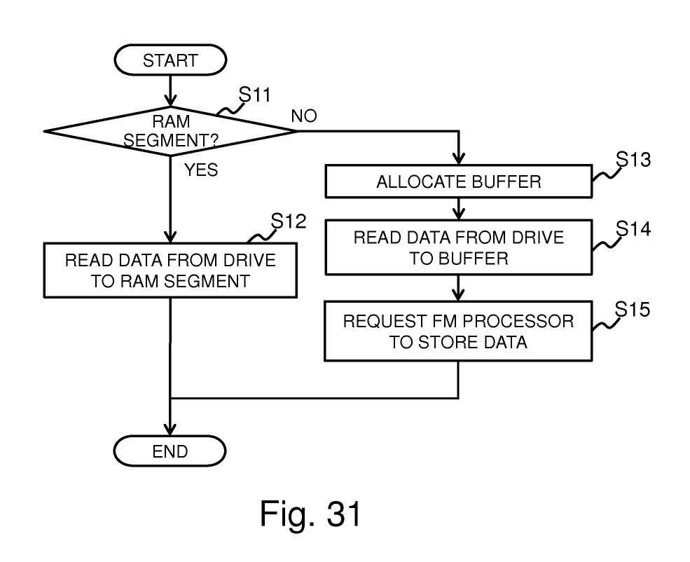

In a case where the result is a cache hit (Step S4: YES), the CPU 33 advances the processing to Step S122, and, alternatively, in the case of a cache miss (Step S4: NO), executes a staging process (refer to FIG. 31) (Step S121) and advances the processing to Step S122. In the staging process, data is read from a drive (either the HDD 40 or the SSD 41) to the cache segment (either 325 or 343). When the staging process is complete, the state is one in which the read-target data is stored in the cache segment (either 325 or 343).

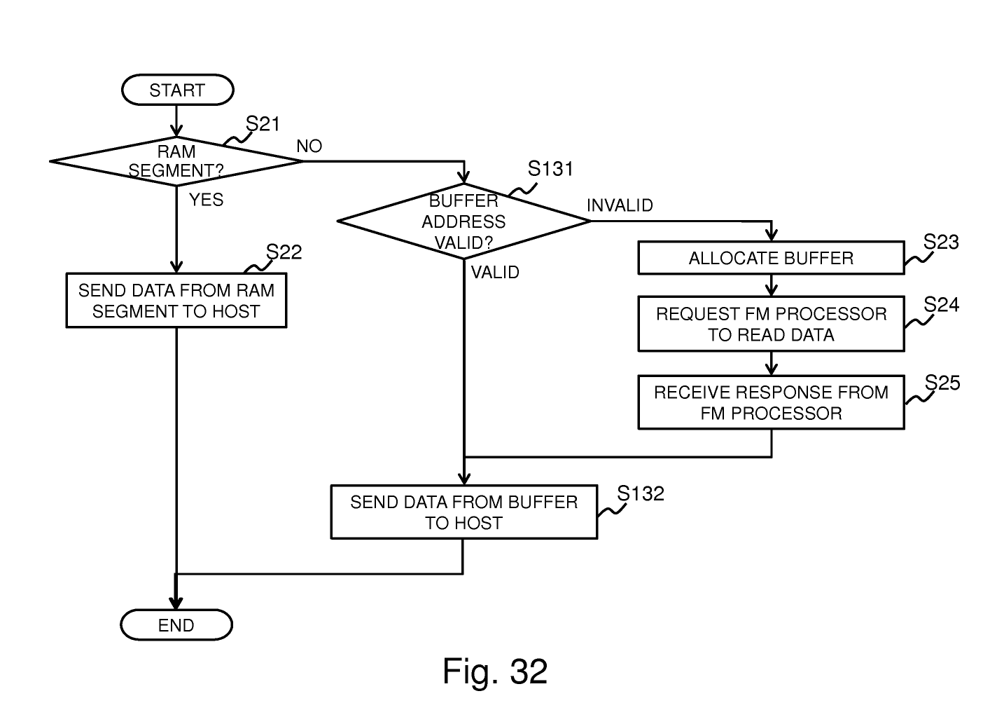

In Step S122, the CPU 33 executes a data send process (refer to FIG. 32) for sending the data stored in the cache segment to the host computer 10.

Next, the CPU 33 sends the status of the completed command to the host computer 10 (Step S7). That is, the CPU 33 returns an error status (for example, CHECK CONDITION) in a case where an error occurred during the processing of the command and the read process did not end normally, and, alternatively, returns a normal status (GOOD) in a case where the read process ended normally.

Next, the CPU 33 determines whether or not a write is being implemented to the FM chip 321 (Step S123). “A write is being implemented to the FM chip 321” signifies a state in which a completion notification has yet to be received from the FM processor 320b subsequent to sending the FM processor 320b a request to write data to the FM chip 321. When the result is true (Step S123: YES), the CPU 33 waits for the completion notification from the FM processor 320b (Step S124), and advances the processing to Step S125. Alternatively, when the result is false (Step S123: NO), the CPU 33 advances the processing to Step S125.

In Step S125, the CPU 33 releases the buffer. Next, the CPU 33 releases (unlocks) the locked slot (Step S8), updates the access monitor table 342 (Step S9), and ends the read command process. The updating of the access monitor table 342, for example, involves adding the bytes of data read in accordance with this read command to the read bytes counter 342e, and incrementing the read command counter 342g.

FIG. 31 is a flowchart of a staging process related to Example 4.

The staging process corresponds to the processing of Step S121 of the read command process of FIG. 29.

First, the CPU 33 checks the type of the cache memory, which is the basis of the cache segment allocated to the read-target address, and determines whether or not the cache segment is a cache segment (a RAM segment) 343 on the RAM 34 (Step S11). Here, the type of the cache memory, which is the basis of the cache segment, can be identified by referencing the memory type 120c of the corresponding SGCT 120.

In a case where the result is that the cache segment is a RAM segment 343 (Step S11: YES), the CPU 33 advances the processing to Step S12, and, alternatively, in a case where the cache segment is not a RAM segment 343 (Step S11: NO), advances the processing to Step S13.

In Step S12, the CPU 33 reads the read-target (staging-target) data from the drive (either the HDD 40 or the SSD 41), stores the data in the RAM segment 343, and ends the staging process.

In the processing of Step S13 and beyond, since the cache segment is not a RAM segment 343, that is, since the cache segment is a cache segment (FM segment) 325 on the FM chip 321, the data read from the drive is not written directly to the FM chip 321, but rather is stored temporarily in the buffer memory 323 of the FM board 32, and thereafter, is written from the buffer memory 323 to the FM chip 321.

First, in Step S13, the CPU 33 reserves an area (a buffer) for storing the data read from the drive in the buffer memory 323. That is, the CPU 33 allocates enough of the buffer memory 323 area to the buffer to store the staging-target data.

Next, the CPU 33 reads the staging-target data from the drive and stores this data in the buffer (Step S14). In this example, the BE I/F 35 receives an instruction from the CPU 33, and stores the data in the buffer of the FM board 32 buffer memory 323 from the drive.

Then, the CPU 33 requests that the FM processor 320b store the data on the buffer memory 323 buffer in the FM chip 321 (Step S15). In response to the request, the FM processor 320b executes a data send process (refer to FIG. 32).

Thereafter, the CPU 33 ends the staging process.

FIG. 32 is a flowchart of a data send process related to Example 4.

The data send process corresponds to the processing of Step S122 of the read command process shown in FIG. 29.

First, the CPU 33 checks the type of the cache memory, which is serving as the basis of the cache segment allocated to the read-target address, and determines whether or not the cache segment is a RAM segment 343 (Step S21). Here, the type of the cache memory serving as the basis of the cache segment can be identified by referencing the memory type 120c of the corresponding SGCT 120.

In a case where the result is that the cache segment is a RAM segment 343 (Step S21: YES), the CPU 33 advances the processing to Step S22, and, alternatively, in a case where the cache segment is not a RAM segment 343 (Step S21: NO), advances the processing to Step S131.

In Step S22, the CPU 33 transfers the read-target (send-target) data from the RAM segment 343 to the host computer 10, and ends the data send process.

In Step S131, the CPU 33 checks whether or not the buffer address 344e of the job control table 344 corresponding to the read/write command is valid. In a case where the result is that the buffer address 344e is valid (Step S131: VALID), the CPU 33 advances the processing to Step S132, and, alternatively, in a case where the buffer address 344e is invalid, advances the processing to Step S23.

In Step S23, the CPU 33 reserves a buffer in the buffer memory 323. That is, the CPU 33 allocates enough of the buffer memory 323 area to store the send-target data.

Next, the CPU 33 requests that the FM processor 320b read the data on the FM chip 321 to the buffer memory 323 buffer (Step S24). In response to the request, the FM processor 320b executes a FM data read process (Refer to FIG. 22). According to the FM data read process, the send-target data is stored in the buffer memory 323. The FM processor 320b, upon ending the FM data read process, returns a complete response to the CPU 33 with respect to the request.

Next, the CPU 33 receives the complete response with respect to the request from the FM processor 320b (Step S25), and advances the processing to Step S132.

In Step S132, the CPU 33 sends the send-target data from the buffer memory 323 to the host computer 10.

### Example 5

An information system related to Example 5 will be explained next.

The difference between the information system related to Example 5 and the information system related to Example 1 is that the information system related to Example 5 is configured to revise the memory type to which a cache segment is allocated, and to move data from an allocated cache segment to a cache segment of a different memory type in accordance with data access characteristics and the like. This makes it possible to store data in an appropriate cache segment, which corresponds to the access characteristics of the data.

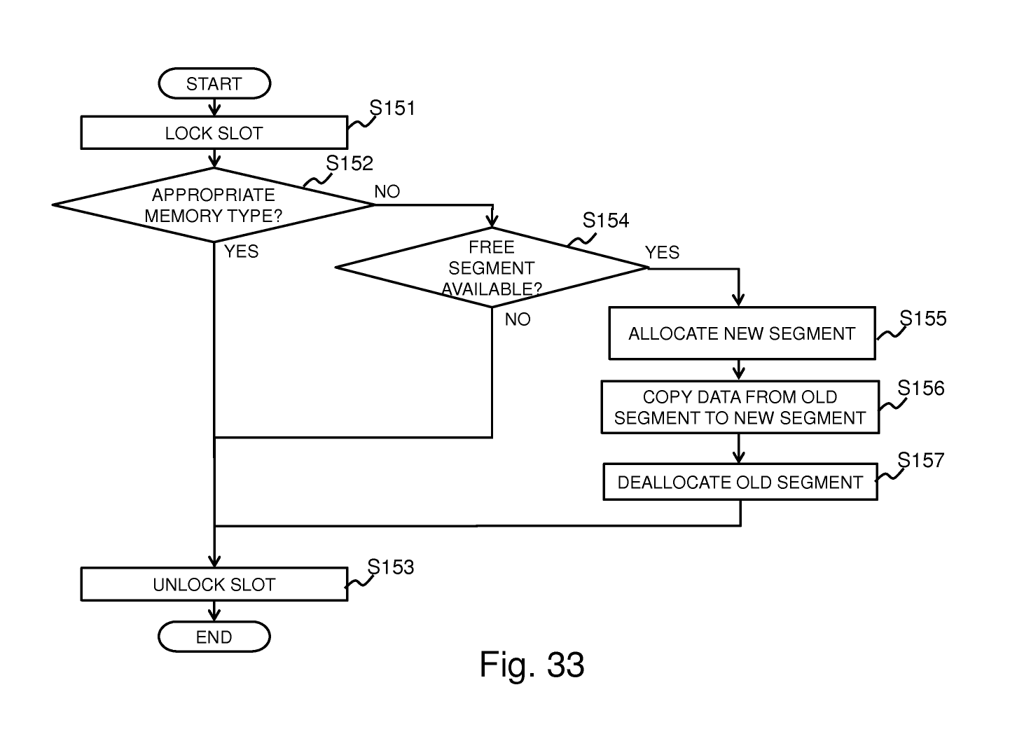

FIG. 33 is a flowchart of a memory type revision process related to Example 5.

The memory type revision process, for example, may be performed on a regular basis with respect to each segment that has been allocated, and when data is moved from one drive to another drive, may be performed for the segment in which the relevant data is stored.

First, the CPU 33 locks the slot comprising the processing-target cache segment (referred to as processing-target segment in the explanation of FIG. 33) (Step S151).

Next, the CPU 33 determines whether or not the memory type of the processing-target segment is appropriate (Step S152). Either all or part of the determination criteria for the cache allocation process shown in FIG. 14 may be used as criteria in this determination. For example, in a case where the access frequency is high or SSD data is stored, the RAM segment 343 is determined to be appropriate, and in cases other than that, the FM segment 325 is determined to be appropriate.

In a case where the result of the determination is true, that is, the memory type is appropriate (Step S152: YES), the CPU 33 releases the slot (Step S153) and ends the memory type revision process. Alternatively, in a case where the result of the determination is false, that is, the memory type is inappropriate (Step S152: NO), the CPU 33 advances to the following processing.

That is, the CPU 33 checks whether there is a free segment of the appropriate memory type (Step S154). In a case where the result is that a free segment of the appropriate memory type does not exist (Strep S154: NO), the CPU 33 releases the slot (Step S153) and ends the memory type revision process.

Alternatively, in a case where a free segment of the appropriate memory type exists (Step S154: YES), the CPU 33 allocates a new segment of the appropriate memory type for the data of the processing-target segment (Step S155). Next, the CPU 33 copies the data from the old cache segment to the new cache segment (Step S156), releases the old cache segment (Step S157), releases the slot (Step S153), and ends the memory type revision process.

A number of examples have been explained hereinabove, but these are illustrated by way of examples of the present invention, and do not purport to limit the scope of the present invention to these examples. That is, it is possible for the present invention to be put into practice in a variety of other modes.

### REFERENCE SIGNS LIST

20 Storage system
30 Storage controller
32 FM board
34 RAM
321 FM chip

1. An information processing apparatus configured to accept an I/O request from a host computer, comprising:
a plurality types of cache memories having different characteristics; and
a control device, which is coupled to the plurality types of cache memories,
wherein the control device:
caches, according to an access characteristic of data associated with the I/O request, the data in any one of the plurality types of the cache memories.

2. The information processing apparatus according to claim 1, wherein the plurality types of the cache memories comprise a first cache memory composed of a first memory, and a second cache memory composed of a second memory having a lower access performance than the first cache memory.

3. The information processing apparatus according to claim 2, wherein
the control device caches data having a higher access frequency than a predetermined threshold preferentially in the first cache memory over the second cache memory.

4. The information processing apparatus according to claim 3, wherein the control device preferentially caches the data in the second cache memory over the first cache memory in a case where the access rate for the data is slower than the threshold.

5. The information processing apparatus according to claim 4, wherein the control device:
collects, for each prescribed region in one or more logical volumes in which data is managed, information related to access with respect to data of the region; and
decides on the threshold related to the access rate based on the information related to access.

6. The information processing apparatus according to claim 3, further comprising:
a buffer memory having a higher access performance than the second cache memory,
wherein when storing the data in the second cache memory, the control device stores the data in the buffer memory, and thereafter, stores the data in the second cache memory from the buffer memory.

7. The information processing apparatus according to claim 3, wherein the first memory is a RAM (Random Access Memory), and the second memory is a flash memory.

8. The information processing apparatus according to claim 3, wherein the control device cashes the data preferentially in the first cache memory over the second cache memory, in a case where the data is target data of a sequential access.

9. The information processing apparatus according to claim 3, wherein the control device caches the data preferentially in the first cache memory, in a case where a storage device in which the data is ultimately managed is comprised of the second memory.

10. The information processing apparatus according to claim 3, wherein the control device cashes the data preferentially in the first cache memory, in a case where the data is used temporarily.

11. The information processing apparatus according to claim 1, wherein the plurality types of the cache memories are a third cache memory comprised of a third memory, and a fourth cache memory for which the number of data updates is restricted more than the third memory, and
the control device cashes data having a high update frequency preferentially in the third cache memory over the fourth cache memory.

12. The information processing apparatus according to claim 11, wherein the third memory is a RAM, and the fourth memory is a flash memory.

13. The cache control method, comprising:
accepting an I/O request from a host computer; and
caching, according to an access characteristic of data associated with the I/O request, the data in any one of multiple cache memories having different characteristics.

14. The cache control method according to claim 13, wherein the multiple cache memories comprise a first cache memory comprised of a RAM, and a second cache memory comprised of a flash memory, and
caching the data having a higher access frequency than a predetermined threshold preferentially in the first cache memory over the second cache memory.

15. The cache control method according to claim 13, wherein the multiple cache memories comprise a first cache memory comprised of a RAM, and a second cache memory comprised of a flash memory, and
caching the data preferentially in the first cache memory over the second cache memory, in a case where the data is a target data of a sequential access.
